(19) United States
(12) Patent Application Publication
(10) Pub. No.: US 2024/0350918 A1
(43) Pub. Date: Oct. 24, 2024

(54) VIRTUAL CHARACTER CONTROL METHOD AND APPARATUS, DEVICE, AND STORAGE MEDIUM

(71) Applicant: Tencent Technology (Shenzhen) Company Limited, Shenzhen (CN)

(72) Inventors: Renjie LI, Shenzhen (CN); Wei FAN, Shenzhen (CN)

(21) Appl. No.: 18/763,843

(22) Filed: Jul. 3, 2024

Related U.S. Application Data
(63) Continuation of application No. PCT/CN2023/086935, filed on Apr. 7, 2023.

(30) Foreign Application Priority Data
May 10, 2022 (CN) 202210507783.7

(51) Int. Cl. A63F 13/56; A63F 13/537

(52) U.S. Cl. CPC A63F 13/56; A63F 13/537

(57) ABSTRACT

This application provides a virtual character control method performed by a computer device. The method includes: displaying a movement control and an attack control on a virtual scene; in response to a first operation on the movement control by a user of the computer device, controlling the first virtual character to move at a movement speed in the virtual scene; while the first virtual character remains in a moving state in the virtual scene, increasing rush energy corresponding to the first virtual character in response to a second operation on the attack control by the user of the computer device; and when the rush energy satisfies a first condition, controlling the first virtual character to accelerate the movement speed until the rush energy corresponding to the first virtual character is drained.

### CROSS-REFERENCE TO RELATED APPLICATIONS

This application is a continuation application of PCT Patent Application No. PCT/CN2023/086935, entitled “VIRTUAL CHARACTER CONTROL METHOD AND APPARATUS, DEVICE, AND STORAGE MEDIUM” filed on Apr. 7, 2023, which claims priority to Chinese Patent Application No. 202210507783.7, entitled “VIRTUAL CHARACTER CONTROL METHOD AND APPARATUS, DEVICE, AND STORAGE MEDIUM” filed on May 10, 2022, both of which are incorporated by reference in their entirety.

### FIELD OF THE TECHNOLOGY

This application relates to the field of computer and Internet technologies, and in particular, to a virtual character control method and apparatus, a device, and a storage medium.

### BACKGROUND OF THE DISCLOSURE

A user can control a virtual character to move in a virtual environment.

In related art, a user controls a virtual character to move through a left wheel. When an operation on the left wheel is detected, a direction indicated by the operation is determined as a movement direction of the virtual character, and the virtual character is controlled to move based on the movement direction.

However, in the foregoing related art, movement manners of the virtual character are undiversified.

### SUMMARY

Embodiments of this application provide a virtual character control method and apparatus, a device, and a storage medium, to enrich movement manners of a virtual character. The technical solutions are as follows:

According to an aspect of embodiments of this application, a virtual character control method is performed by a computer device, and the method includes:
displaying a movement control and an attack control on a virtual scene;
in response to a first operation on the movement control by a user of the computer device, controlling the first virtual character to move at a movement speed in the virtual scene;
while the first virtual character remains in a moving state in the virtual scene, increasing rush energy corresponding to the first virtual character in response to a second operation on the attack control by the user of the computer device; and
when the rush energy satisfies a first condition, controlling the first virtual character to accelerate the movement speed until the rush energy corresponding to the first virtual character is drained.

According to an aspect of embodiments of this application, an embodiment of this application provides a computer device, including a processor and a memory, the memory having a computer program stored therein, and the computer program, when executed by the processor, causing the computer device to implement the foregoing virtual character control methods.

According to an aspect of embodiments of this application, an embodiment of this application provides a non-transitory computer-readable storage medium, having a computer program stored thereon, the computer program, when executed by a processor of a computer device, causing the computer device to implement the foregoing virtual character control methods.

The technical solutions provided in embodiments of this application can achieve the following beneficial effects:

During movement of a virtual character, rush energy is accumulated through an operation on an attack control, and the virtual character is controlled to speed up when the accumulated rush energy satisfies a specific condition, so that movement manners of the virtual character are enriched. In addition, when the virtual character is controlled to speed up, there is need to provide a specific control, and the virtual character can be controlled to speed up based on triggering of a combination of existing controls. In this way, functions of existing movement controls and skill controls can be enriched, an interface layout can be simplified, and unwanted operations caused by an excessively complex interface layout can be reduced.

### BRIEF DESCRIPTION OF THE DRAWINGS

FIG. 1 is a schematic diagram of a virtual character control system according to an embodiment of this application.

FIG. 2 is a schematic diagram of an example of a virtual character control system.

FIG. 3 is a flowchart of a virtual character control method according to an embodiment of this application.

FIG. 4 is a schematic diagram of an example of a rush energy prompt bar.

FIG. 5 is a schematic diagram of an example of a movement speed indication icon.

FIG. 6 is a schematic diagram of an example in which a first virtual character speeds up.

FIG. 7 is a flowchart of a virtual character control method according to another embodiment of this application.

FIG. 8 is a schematic diagram of an example in which a first virtual character quickly stops moving.

FIG. 9 is a flowchart of a virtual character control method according to another embodiment of this application.

FIG. 10 is a flowchart of a virtual character control method according to another embodiment of this application.

FIG. 11 is a schematic diagram of an example of a switching method for a target movement state.

FIG. 12 is a flowchart of a virtual character control method according to another embodiment of this application.

FIG. 13 is a schematic diagram of an example of a movement manner of a first virtual character in a non-linear deceleration state.

FIG. 14 is a schematic diagram of an example of a determining method for a target direction.

FIG. 15 is a flowchart of a virtual character control method according to another embodiment of this application.

FIG. 16 is a schematic diagram of an example of a movement manner of a first virtual character in a linear deceleration state.

FIG. 17 is a flowchart of a virtual character control method according to another embodiment of this application.

FIG. 18 is a schematic diagram of an example of a movement manner of a first virtual character in an acceleration state.

FIG. 19 is a flowchart of a virtual character control method according to another embodiment of this application.

FIG. 20 is a schematic diagram of an example of a movement manner of a first virtual character in a first deceleration state.

FIG. 21 is a flowchart of a virtual character control method according to another embodiment of this application.

FIG. 22 is a schematic diagram of an example of a movement manner of a first virtual character in a second deceleration state.

FIG. 23 to FIG. 27 are block diagrams of virtual character control apparatuses according to embodiments of this application.

FIG. 28 is a block diagram of a structure of a terminal device according to an embodiment of this application.

### DESCRIPTION OF EMBODIMENTS

To make the objectives, technical solutions, and advantages of this application clearer, the following further describes implementations of this application in detail with reference to the accompanying drawings.

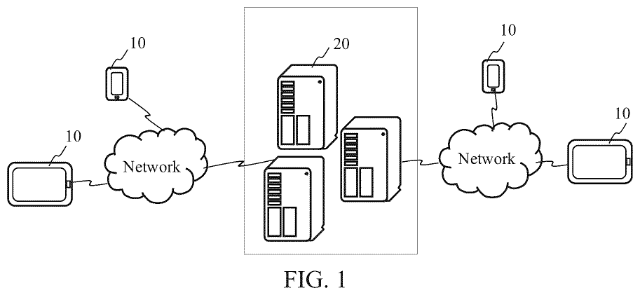

FIG. 1 is a schematic diagram of a virtual character control system according to an embodiment of this application. The virtual character control system may include a terminal device 10 and a server 20.

The terminal device 10 may be an electronic device such as a mobile phone, a tablet computer, a game console, an e-book reader, a multimedia playback device, a wearable device, or a personal computer (PC), which is not limited in embodiments of this application. In some embodiments, the terminal device 10 includes a client of an application. The application may be an application that needs to be downloaded for installation or may be a tap-to-use application, which is not limited in embodiments of this application. For example, the application may be a multiplayer online battle arena (MOBA) game, a third-personal shooting game (TPS), a multiplayer gun shooting survival game, an augmented reality (AR) application, a three-dimensional map program, a social application, an interactive entertainment application, or the like. Additionally, for different applications, forms of virtual characters provided by the applications and corresponding functions may also be different and can be pre-configured based on actual requirements, which are not limited in embodiments of this application. Certainly, in an exemplary embodiment, the same application may alternatively provide users with a plurality of virtual characters having different functions, which are not limited in embodiments of this application.

The foregoing virtual characters are virtual characters controlled by users in an application. Using the application being a game application as an example, the virtual characters are game characters controlled by users in the game application. The virtual characters may be in a form of human beings, animals, cartoons, or another form, which is not limited in embodiments of this application. The virtual characters may be displayed in a three-dimensional form or a two-dimensional form, which is not limited in embodiments of this application.

The server 20 is configured to provide a background service for the terminal device 10. The server 20 may be one server, a server cluster including a plurality of servers, or a cloud computing service center. In some embodiments, the server 20 may be a backend server of the client of the foregoing application. In an exemplary embodiment, the server 20 provides background services for a plurality of terminal devices 10.

Data is transmitted between the terminal device 10 and the server 20 over a network.

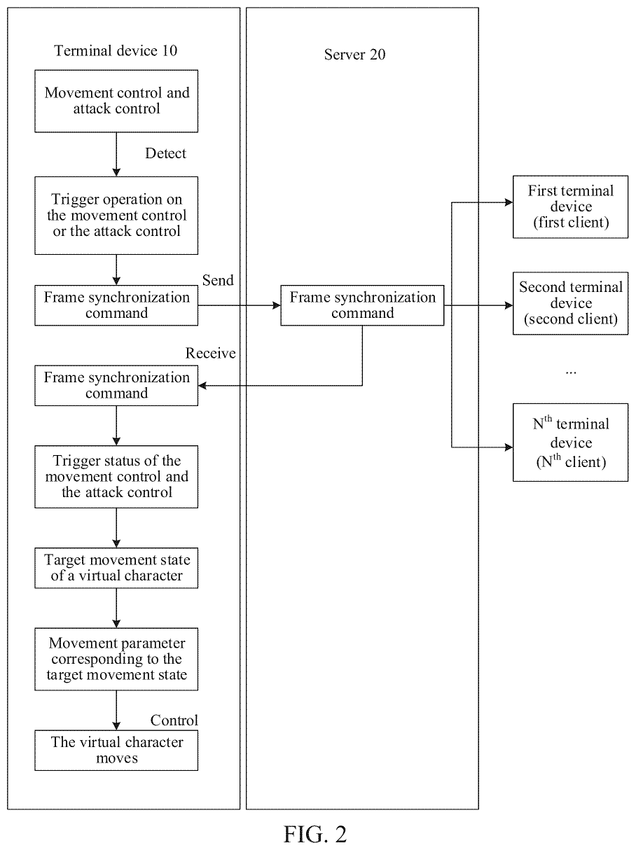

In this embodiment of this application, a user may control the virtual character in the foregoing application to move flexibly. For example, as shown in FIG. 2, the terminal device 10 displays a movement control configured to control a virtual character to move and an attack control configured to control the virtual character to perform an attack action. When a trigger operation on the movement control or the attack control is detected, the terminal device 10 sends a frame synchronization command to the server 20, and then the server 20 forwards the frame synchronization command to a plurality of terminal devices running clients of applications. The plurality of terminal device include the terminal device 10. Accordingly, after receiving the frame synchronization command, the terminal device 10 determines a target movement state of the virtual character based on trigger status of the movement control and the attack control, obtains a movement parameter corresponding to the target movement state from a preset movement parameter set based on the target movement state, and controls the virtual character to move based on the movement parameter.

The foregoing descriptions of FIG. 2 are merely exemplary and explanatory, and in an exemplary embodiment, functions of the terminal device 10 and the server 20 may be flexibly configured and adjusted, which are not limited in embodiments of this application.

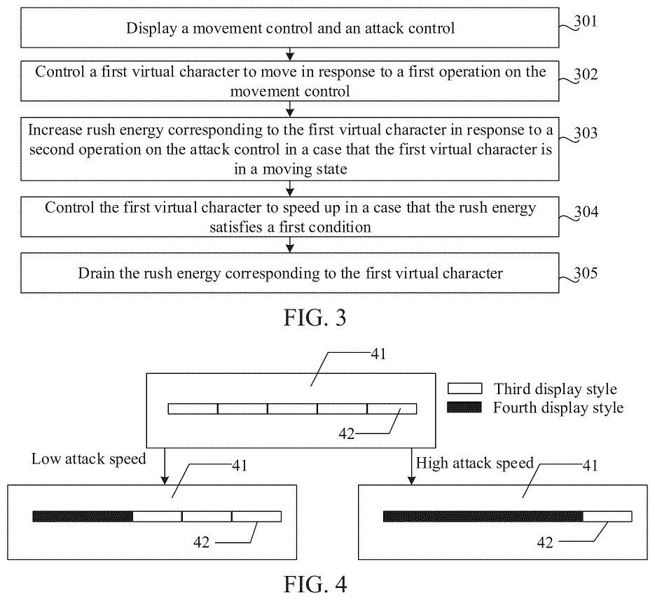

FIG. 3 is a flowchart of a virtual character control method according to an embodiment of this application. The method is performed by the terminal device 10 of the virtual character control system shown in FIG. 1. For example, operations may be performed by the client of the application in the terminal device 10. The method may include at least one operation in the following operations (301-305):

Operation 301: Display a movement control and an attack control.

In this embodiment of this application, the movement control and the attack control are displayed in a user interface. The movement control is a joystick control configured to control a first virtual character to move, and the attack control is configured to control the first virtual character to perform an attack action. The first virtual character is a virtual character controlled by a user account. In some embodiments, the attack action is an action performed by the first virtual character that can cause harm to a target of the action. The action includes but is not limited to at least one of the following: reduction in a health value, reduction in a defensive power, reduction in an attack power, or a decrease in a movement speed, which is not limited in embodiments of this application.

In some embodiments, the foregoing user interface includes a virtual environment picture. After the application is started, the virtual environment picture and a plurality of controls configured to control the first virtual character are displayed by the client in the user interface. In some embodiments, the plurality of controls include controls configured to control virtual objects to move and attack controlling controls configured to control virtual characters to perform attack operations.

Certainly, in another possible implementation, the foregoing user interface does not include a virtual environment picture. For example, to reduce occlusion the controls on the virtual environment picture, after the application is started, the virtual environment picture is displayed on a client of a first terminal device, and the plurality of controls configured to control the first virtual character are displayed on a client of a second terminal device. After detecting a trigger operation by a user on the controls, the second terminal device generates a corresponding instruction based on the trigger operation, and sends the instruction to the first terminal device. Accordingly, after receiving the instruction, the first terminal device controls the first virtual character to perform a corresponding action based on the instruction. The foregoing plurality of controls include the movement control and the attack control.

In this embodiment of this application, the foregoing virtual environment picture includes the first virtual character. The client may obtain the virtual environment picture from a third-person viewing angle. For example, a virtual camera is arranged in the virtual environment, and the client obtains a virtual environment picture from the virtual camera. In a possible implementation, a position of the virtual camera in the virtual environment is fixed. In another possible implementation, a position of the virtual camera in the virtual environment is adjustable, and the position of the virtual camera may be adjusted based on actual circumstances, to flexibly view different positions in the virtual environment.

In some embodiments, an attack operation of the first virtual character includes an ordinary attack and a skill attack. When the ordinary attack is performed, there is no need to consume virtual resources, and there is no cooldown period between adjacent ordinary attacks. There is a cooldown period between adjacent skill attacks. In addition, due to different definitions of virtual characters, when skill attacks of some virtual characters are performed, there is a need to consume the virtual resources. In an exemplary embodiment, the ordinary attack may also be referred to as a basic a, and the skill attack may also be referred to as a non-ordinary attack.

In a possible implementation, the attack control is any one of a plurality of attack controlling controls. In some embodiments, the attack control is an attack controlling control selected from the plurality of attack controlling controls and configured by a game designer. For example, the designer configures an ordinary attack control as the attack control. The ordinary attack control is configured to control the first virtual character to perform the ordinary attack.

In another possible implementation, the attack control is an ordinary attack control among the plurality of attack controlling controls or a skill attack control in an abnormal response state. The ordinary attack control is configured to control the first virtual character to perform the ordinary attack, and the skill attack control is configured to control the first virtual character to cast a skill. The abnormal response state is a state in which a skill attack control cannot control the first virtual character to cast a corresponding skill. For example, when virtual resources required for perform a skill attack by the first virtual character are insufficient, a skill attack control corresponding to the skill attack is in an abnormal response state. In some embodiments, after displaying the plurality of attack controlling controls, the client obtains response states corresponding to the plurality of attack controlling controls. The plurality of attack controlling controls include an ordinary attack control and at least one skill attack control. Further, when there is a control in an abnormal response state in the plurality of attack controlling controls, the client determines the control in an abnormal response state as the attack control. When there is no control in an abnormal response state in the plurality of attack controlling controls, the client determines the ordinary attack control as the attack control. The response state is for indicating whether the first virtual character can perform a skill corresponding to the skill attack control.

In some embodiments, to allow the user to quickly determine the attack control from the plurality of skill attack controls, when the skill attack control switches from a non-abnormal response state to an abnormal response state, the client controls the skill attack control to change from a first display style to a second display style. In this way, the attack control determined from the plurality of skill attack controls can be intuitively displayed to the user.

Operation 302: Control the first virtual character to move in response to a first operation on the movement control.

In this embodiment of this application, after displaying the foregoing movement control, the client detects the movement control, and when the first operation on the movement control is detected, the client controls the first virtual character to move.

In some embodiments, the foregoing first operation includes a direction adjustment operation and a non-direction-adjustment operation. In a possible implementation, the first operation is the direction adjustment operation. After detecting the direction adjustment operation on the movement control, the client obtains a target direction indicated by the direction adjustment operation, and the client controls the first virtual character to move in the target direction. In another possible implementation, the first operation is not the direction adjustment operation. In some embodiments, the first operation is a non-direction-adjustment operation. After detecting the non-direction-adjustment operation on the movement control, the client controls the first virtual character to move in a historical movement direction. If the first virtual character is moving before the foregoing non-direction-adjustment is detected by the client, the historical movement direction is a movement direction of the first virtual character when the foregoing non-direction-adjustment is detected by the client. If the first virtual character is in a static (non-moving) state before the foregoing non-direction-adjustment operation is detected by the client, the historical movement direction is an orientation of the first virtual character when the foregoing non-direction-adjustment operation is detected by the client.

In some embodiments, the client controlling the first virtual character to move includes controlling the first virtual character to accelerate and controlling the first virtual character to move uniformly. For example, when the first operation on the movement control is detected by the client, if a movement speed of the first virtual character does not reach a maximum movement speed, the client controls the first virtual character to accelerate until the movement speed of the first virtual character reaches the maximum movement speed. If the movement speed of the first virtual character reaches the maximum movement speed, the client controls the first virtual character to move uniformly at the maximum movement speed.

Operation 303: Increase rush energy corresponding to the first virtual character in response to a second operation on the attack control when the first virtual character is in a moving state.

In this embodiment of this application, after displaying the foregoing attack control, the client detects the attack control. When the second operation on the attack control is detected and the first virtual character is in the moving state, the client increases the rush energy corresponding to the first virtual character.

In some embodiments, the rush energy may be understood as virtual energy that changes a movement speed of a virtual object in a virtual environment. To allow the user to determine accumulated rush energy, the client displays the accumulated rush energy. The foregoing user interface further includes a rush energy prompt bar, and the rush energy prompt bar is configured to indicate rush energy accumulated by the first virtual character. In some embodiments, the accumulation of the rush energy is related to at least one of an attack speed of the first virtual character, a quantity of hits of an attack action, or duration of the second operation.

In a possible implementation, the accumulation of the rush energy is related to the attack speed of the first virtual character. In some embodiments, when the second operation on the attack control is detected, the client updates the rush energy based on the attack speed of the first virtual character, and displays an increase process of the rush energy in the rush energy prompt bar. The attack speed of the first virtual character is related to a frequency of the second operation. For example, if the second operation is a click/tap operation, when the terminal device senses that the user performs the second operation on the attack control twice per second, the attack speed of the first virtual character is also twice per second.

In some embodiments, an increase speed of the rush energy is in positive correlation with the foregoing attack speed. In other words, a high attack speed indicates a higher increase speed of the rush energy, and a lower attack speed indicates a lower increase speed of the rush energy.

In a possible implementation, the accumulation of the rush energy is related to the quantity of hits of an attack action. In some embodiments, when the second operation on the attack control is detected, the client controls the first virtual character to perform an attack action on a second virtual character within an attack range. The attack range is an effective range of an attack action corresponding to the attack control. The first virtual character can perform an attack action on any other virtual characters within the attack range. Further, the client updates the rush energy based on a quantity of hits of the attack action, and displays an increase process of the rush energy in the rush energy prompt bar. An increase speed of the rush energy is in positive correlation with the foregoing quantity of hits. In other words, a larger quantity of hits indicates a higher increase speed of the rush energy, and a smaller quantity of hits indicates a lower increase speed of the rush energy.

In a possible implementation, the accumulation of the rush energy is related to the duration of the second operation. In some embodiments, when the second operation on the attack control is detected, the client updates the rush energy based on the duration of the second operation, and displays an increase process of the rush energy in the rush energy prompt bar. For example, the client records the duration of the second operation on the attack control, and determines, based on the duration of the second operation, the rush energy accumulated due to the second operation. An increase speed of the rush energy is in positive correlation with the foregoing duration. In other words, longer duration indicates a higher increase speed of the rush energy, and shorter duration indicates a lower increase speed of the rush energy. Based on an action effect of the second operation, constantly superimposing the rush energy accumulated through the operation enriches gameplay and is beneficial to improvement of fun of a game.

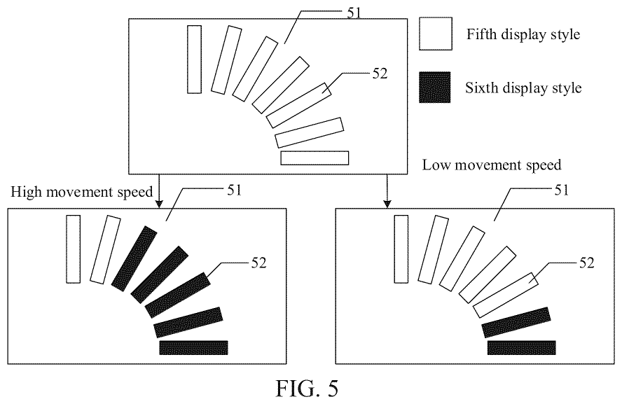

In some embodiments, in this embodiment of this application, the rush energy prompt bar includes a plurality of first sub-icons, and the first sub-icons indicate the rush energy that has been accumulated. An example in which the accumulation of the rush energy is related to the attack speed of the first virtual character is used. For example, a rush energy prompt bar 41 in FIG. 4 includes a plurality of first sub-icons 42, and the first sub-icons 42 correspond to a third display style and a fourth display style. The attack speed of the first virtual character is in positive correlation with a quantity of the first sub-icons 42 displayed in the fourth display style. In other words, a higher attack speed of the first virtual character indicates more first sub-icons 42 displayed in the fourth display style in the rush energy prompt bar 41, and a lower attack speed of the first virtual character indicates fewer first sub-icons 42 displayed in the fourth display style in the rush energy prompt bar 41.

Operation 304: Control the first virtual character to speed up when the rush energy satisfies a first condition.

In some embodiments, the first condition is for controlling a threshold for occurrence of the speed-up of the first virtual character. The speed-up means that the first virtual character moves at a non-constant movement speed in a virtual environment. In this embodiment of this application, the client controls the first virtual character to speed up when the rush energy satisfies the first condition. A movement speed of the first virtual character during the speed-up is higher than a movement speed of the first virtual character before the speed-up. In some embodiments, the foregoing first condition means that the rush energy is greater than a threshold. In some embodiments, the threshold is preset.

For example, the threshold is equal to maximum rush energy that can be accumulated by a virtual character, and when the rush energy is full (to be specific, the threshold is equal to the maximum rush energy), the client determines that the rush energy satisfies the first condition. FIG. 4 is used as an example. When all of the first sub-icons 42 are displayed in the fourth display style, it is determined that the rush energy satisfies the first condition. The movement speed of the first virtual character before the speed-up is a movement speed of the first virtual character when the rush energy satisfies the first condition. In some embodiments, when no speed-up is performed, the movement speed of the first virtual character in the virtual environment is fixed (for example, v₀), and the movement speed of the first virtual character before the speed-up is the fixed movement speed, namely, v₀.

In some embodiments, that the client controls the first virtual character to speed up when the rush energy satisfies the first condition includes: The client controls the first virtual character to speed up in the virtual environment in response to a third operation on the attack control. The third operation includes but is not limited to at least one of the following: a click/tap operation, a slide operation, or a long press/touch and hold operation.

In some embodiments, when the rush energy satisfies the first condition, the client controls the first virtual character to speed up in the virtual environment in response to the first operation of the movement control and the third operation on the attack control. In some embodiments, the client controls the first virtual character to move based on the movement speed before the speed-up in response to the third operation disappearing. The third operation disappearing means that the client senses that a signal of the third operation disappears from a screen. For example, the third operation disappearing means that the client senses that a click/tap operation on the attack control disappears.

In some embodiments, that the client controls the first virtual character to speed up when the rush energy satisfies the first condition includes: The client automatically controls the first virtual character to speed up when the rush energy satisfies the first condition. In other words, in this embodiment, the speed-up is automatically triggered. According to this method, operation complexity of controlling the virtual character to speed up can be reduced. In some embodiments, the client controls the first virtual character to speed up in a target movement direction when the rush energy satisfies the first condition. The target movement direction is a direction of the first virtual character to speed up. In some embodiments, the target movement direction is a movement direction of the first virtual character when the rush energy satisfies the first condition. Controlling a virtual character to speed up based on a determined target movement direction allows a user to control the virtual character to speed up in a specific direction. In this way, predictability of the speed-up of the virtual character can be improved, and the user can determine, based on game battling, a timing for controlling the virtual character to speed up.

In a possible implementation, to reduce a computation amount during the speed-up, a movement direction of the first virtual character cannot be changed during the controlling the first virtual character to speed up. In some embodiments, the client directly controls the first virtual character to speed up in the target movement direction when it is detected that the rush energy satisfies the first condition. In some embodiments, the client controls the first virtual character to speed up in a direction opposite to the target movement direction when it is detected that the rush energy satisfies the first condition. Controlling the first virtual character to move in the direction opposite to the target movement direction is beneficial to controlling the first virtual character to evade an attack action in the virtual environment, so as to improve richness of the movement of the first virtual character.

In some embodiments, the client sends a stop detection instruction to an operating system of the terminal device running the application. The stop detection instruction is configured for controlling the operating system of the terminal device to stop detecting an operation on the movement control, to reduce energy consumption of the terminal device. In some implementations, the foregoing stop detection instruction includes duration of the speed-up. The operating system of the terminal device determines an end moment of the speed-up operation based on the duration of the speed-up. After the duration of the speed-up ends, the operating system automatically resumes detecting the operation on the movement control. In some other implementations, after the duration of the speed-up ends, the client sends a detection recovery instruction to the operating system. The detection recovery instruction is configured for controlling the operating system of the terminal device to return to normal. After receiving the detection recovery instruction, the operating system resumes detecting the operation on the movement control.

In another possible implementation, to improve movement flexibility of the first virtual character, the movement direction of the first virtual character can be changed during the foregoing speed-up. In some embodiments, when the client detects that the rush energy satisfies the first condition, if no direction adjustment operation on the movement control is detected, the client controls the first virtual character to speed up in the target movement direction. If the direction adjustment operation on the movement control is detected, the client controls the first virtual character to speed up in the target direction indicated by the direction adjustment operation. In some embodiments, the direction adjustment operation on the movement control is a slide operation performed on the movement control. In some embodiments, the direction adjustment operation on the movement control includes a slide operation. The target direction is a direction indicated by the direction adjustment operation. In some embodiments, the target direction is different from the target movement direction.

In some embodiments, that if the direction adjustment operation on the movement control is detected, the client controls the first virtual character to speed up in the target direction indicated by the direction adjustment operation includes: If the client determines that a termination signal of the direction adjustment operation is in a corresponding first area of the movement control, the client determines a direction corresponding to the first area as the target movement direction. Then the client controls the first virtual character to speed up in the target direction. For example, the movement control includes six areas, namely, an area 1, an area 2, an area 3, an area 4, an area 5, and an area 6, and different areas correspond to different movement directions. If the client determines that the termination signal of the direction adjustment operation is in the corresponding area 1 of the movement control, the client uses a direction 1 corresponding to the area 1 as the target direction, and the client controls the first virtual character to speed up in the direction 1.

In some embodiments, that the client controls the first virtual character to speed up when the rush energy satisfies the first condition includes: The client detects whether there is the direction adjustment operation on the movement control. When no direction adjustment operation on the movement control is detected, the client performs the operation of controlling the first virtual character to speed up in a target movement direction. When the direction adjustment operation on the movement control is detected, the client controls the first virtual character to speed up in the target direction indicated by the direction adjustment operation.

The foregoing method allows a speed-up direction of a virtual character to be controllable, and a direction adjustment operation allows a user to control the virtual character to speed up in any direction in a virtual environment, so that speed-up movement flexibility of the virtual character can be improved, and operation methods for controlling the virtual character to move can be enriched.

In some embodiments, that the client controls the first virtual character to speed up in a target movement direction includes: The client controls the first virtual character to accelerate until the movement speed of the first virtual character increases to a maximum speed corresponding to the speed-up. The client controls the first virtual character to decelerate until the movement speed of the first virtual character decreases from the maximum speed corresponding to the speed-up to the movement speed before the speed-up.

In some embodiments, the maximum speed corresponding to the speed-up is a maximum speed of the virtual character to move in the virtual environment. In some embodiments, the maximum speed corresponding to the speed-up is preset. For example, the maximum speed corresponding to the speed-up is 1.5 times the movement speed before the speed-up. In some embodiments, the maximum speed corresponding to the speed-up is directly proportional to the rush energy accumulated by the first virtual character. To be specific, more rush energies accumulated by the first virtual character indicate a higher maximum speed corresponding to the speed-up, and less rush energies accumulated by the first virtual character indicate a lower maximum speed corresponding to the speed-up. The maximum speed corresponding to the speed-up is set based on actual needs, which is not limited in this application.

In some embodiments, to improve reality of the speed-up of the first virtual character, the foregoing speed-up process includes an acceleration process and a deceleration process. When it is detected that the rush energy satisfies the first condition, the client controls the first virtual character to accelerate until the movement speed of the first virtual character increases to the maximum speed corresponding to the speed-up. Then the client controls the first virtual character to decelerate until the movement speed of the first virtual character decreases from the maximum speed corresponding to the speed-up to the movement speed before the speed-up. In some embodiments, in the foregoing acceleration process, the client obtains an acceleration corresponding to the acceleration process, and controls the first virtual character to accelerate based on the acceleration corresponding to the acceleration process.

In this way, speed-up of a virtual character is of different levels, and accelerating first and then decelerating during the speed-up is beneficial to helping a player understand a process of the speed-up. The speed-up is divided into two stages, namely, acceleration and deceleration. Because movement effects of the acceleration stage and the deceleration stage can be perceived and distinguished by naked eyes, the player may determine, based on the movement effect of the virtual character during the speed-up, that a current moment is in the acceleration stage or the deceleration stage of the speed-up, to estimate an end moment of the speed-up and plan ahead of time a further operation that needs to be performed on the virtual character after the speed-up. According to this method, operability of the virtual character can be improved, and gameplay can be enriched. In addition, according to this method, the speed-up of the virtual character is closer to real speed-up.

Operation 305: Drain the rush energy corresponding to the first virtual character.

In some embodiments, the client controls the first virtual character to speed up and drain the rush energy corresponding to the first virtual character when the rush energy satisfies the first condition. As shown in FIG. 4, when the rush energy satisfies the first condition, the client controls the first virtual character to speed up, and change the display styles of all of the first sub-icons 42 from the fourth display style to the third display style.

In some embodiments, the client drains all of the rush energy corresponding to the virtual character or part of the rush energy corresponding to the virtual character.

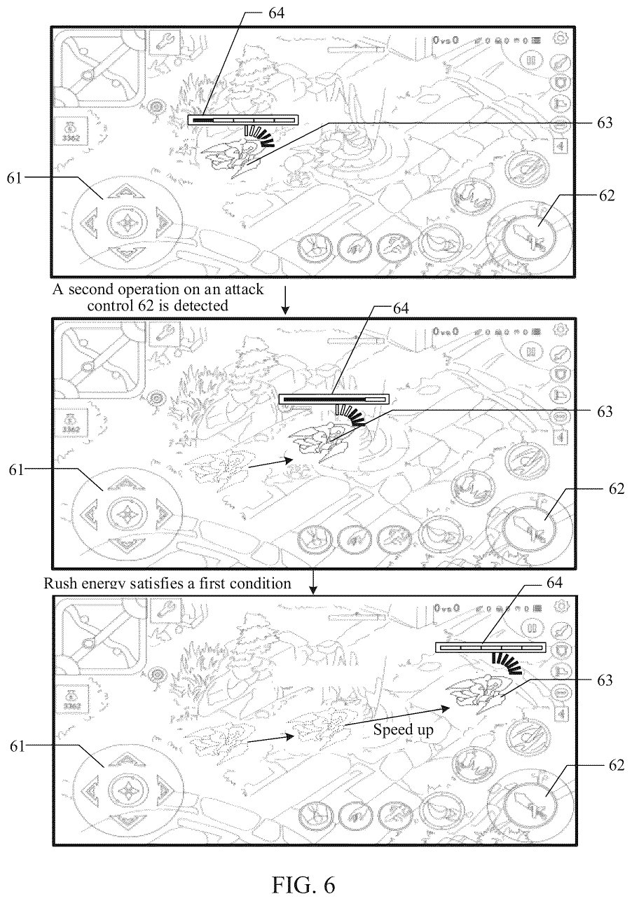

In some embodiments, to allow the user to intuitively grasp the movement speed of the first virtual character, the user interface further includes a movement speed indication icon. In this embodiment of this application, the client displays the movement speed indication icon of the first virtual character. The movement speed indication icon is configured to indicate the movement speed of the first virtual character. Further, the client obtains the movement speed of the first virtual character, and changes a display style of the movement speed indication icon based on the movement speed. For example, as shown in FIG. 5, a movement speed indication icon 51 includes a plurality of second sub-icons 52, and the second sub-icons 52 correspond to a fifth display style and a sixth display style. The movement speed of the first virtual character is in positive correlation with a quantity of the second sub-icons 52 displayed in the sixth display style. To be specific, a higher movement speed of the first virtual character indicates more second sub-icons 52 displayed in the sixth display style in the movement speed indication icon 51, and a lower movement speed of the first virtual character indicates fewer second sub-icons 52 displayed in the sixth display style in the movement speed indication icon 51.

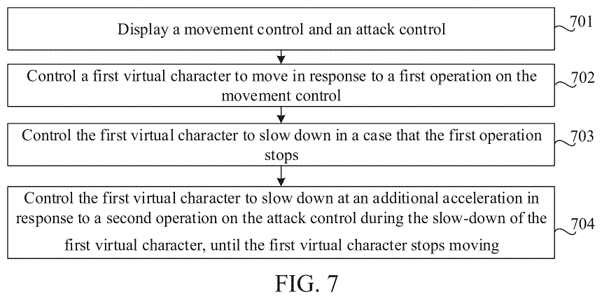

For example, as shown in FIG. 6, a user interface includes a movement control 61 and an attack control 62. When a first operation on the movement control 61 is detected, the client controls a first virtual character 63 to move. Further, when a second operation on the attack control 62 is detected, the client displays an increase process of rush energy in a rush energy prompt bar 64. Then, when the rush energy satisfies a first condition, the client controls the first virtual character 63 to speed up, and drains the rush energy corresponding to the first virtual character 63 in the rush energy prompt bar 64.

The foregoing descriptions of operation 304 and operation 305 are merely exemplary and explanatory, and in an exemplary embodiment, an execution order of operation 304 and operation 305 is not limited. For example, when the rush energy satisfies the first condition, the client may first control the first virtual character to speed up, and then drain the rush energy corresponding to the first virtual character; when the rush energy satisfies the first condition, the client may first drain the rush energy corresponding to the first virtual character, and then control the first virtual character to speed up; when the rush energy satisfies the first condition, client may control the first virtual character to speed up and drain the rush energy corresponding to the first virtual character simultaneously; or the like, which is not limited in embodiments of this application.

In some embodiments, the client draining the rush energy corresponding to the first virtual character may be understood as consuming the rush energy accumulated through performing the attack operation by the first virtual character to increase the movement speed of the first virtual character.

In conclusion, in the technical solutions provided in embodiments of this application, during movement of a virtual character, rush energy is accumulated through an operation on an attack control, and the virtual character is controlled to speed up when the accumulated rush energy satisfies a specific condition, so that movement manners of the virtual character are enriched. In addition, when the virtual character is controlled to speed up, there is need to provide a specific control, and the virtual character can be controlled to speed up based on triggering of a combination of existing controls. In this way, functions of existing movement controls and skill controls can be enriched, an interface layout can be simplified, and unwanted operations caused by an excessively complex interface layout can be reduced.

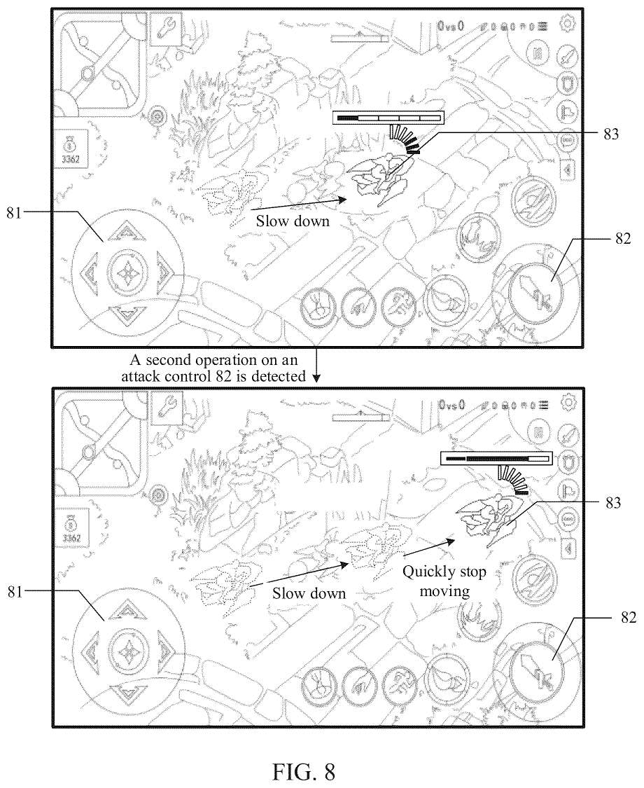

FIG. 7 is a flowchart of a virtual character control method according to another embodiment of this application. The method is performed by the terminal device 10 of the virtual character control system shown in FIG. 1. For example, operations may be performed by the client of the application in the terminal device 10. The method may include at least one operation in the following operations (701-704):

Operation 701: Display a movement control and an attack control.

This operation is the same as or similar to operation 301 in the foregoing embodiment. For details, reference may be made to the foregoing description. Details are not described herein again.

Operation 702: Control a first virtual character to move in response to a first operation on the movement control.

In this embodiment of this application, after displaying the foregoing movement control, the client detects the movement control, and when the first operation on the movement control is detected, the client controls the first virtual character to move. In some embodiments, the foregoing first operation includes a direction adjustment operation and a non-direction-adjustment operation.

In some embodiments, the client controlling the first virtual character to move includes controlling the first virtual character to accelerate and to move uniformly. In some embodiments, when the first operation on the movement control is detected, the client controls the first virtual character to accelerate until a movement speed of the first virtual character reaches a maximum movement speed. Further, the client controls the first virtual character to move uniformly at the maximum movement speed.

Accelerating uniformly allows a virtual character to reach a start speed, so that there is a start and accelerate process in a movement process of the virtual character, thereby improving simulation of the movement process of the virtual character.

Operation 703: Control the first virtual character to slow down when the first operation stops.

In this embodiment of this application, the client controls the first virtual character to slow down when it is detected that the first operation stops. In some embodiments, the client obtains an acceleration corresponding to the slow-down. Further, the client controls the first virtual character to slow down uniformly based on the acceleration corresponding to the slow-down.

In some embodiments, during the slow-down of the first virtual character, if no second operation on the attack control is detected, the client continuously controls the first virtual character to slow down uniformly, until the first virtual character stops moving. In some embodiments, an acceleration during the uniform slow-down is preset. The client may determine time consumption of the uniform slow-down based on the movement speed of the first virtual character and the acceleration during the uniform slow-down. Further, if a movement direction of the first virtual character cannot be changed during the uniform slow-down, the client may determine ahead of time a movement path of the first virtual character during the uniform slow-down. In a multiplayer competition game, the client further needs to transmit position information of the first virtual character to a server, and the server sends the position information of the first virtual character to clients running on other terminal devices. In this case, configuring the first virtual character to slow down uniformly allows the server and other clients to know ahead of time the position information of the first virtual character in a virtual environment. According to this method, a problem the position information of the first virtual character obtained by a plurality of clients is out of synchronization of due to network transmission delay.

Controlling the first virtual character to slow down uniformly allows the terminal device to estimate time consumption of the uniform slow-down, so that a computation amount of the terminal device and power consumption of the terminal device can be reduced.

Operation 704: Control the first virtual character to slow down at an additional acceleration in response to the second operation on the attack control during the slow-down of the first virtual character, until the first virtual character stops moving.

In some embodiments, during the slow-down of the first virtual character, if the second operation on the attack control is detected, the client controls the first virtual character to slow down at the additional acceleration, until the first virtual character stops moving. Slowing down at the additional acceleration is for shortening a time period for the first virtual character to slow down to stop moving. For example, the client controls the first virtual character to slow down when the first operation stops. If the client detects no second operation on the attack control, the first virtual character needs to consume five seconds in a process of slowing down to stop moving. If the client detects the second operation on the attack control, the first virtual character needs to consume four seconds in a process of slowing down to stop moving.

In this embodiment of this application, during the slow-down of the first virtual character, if the second operation on the attack control is detected, the client obtains the additional acceleration, and updates the foregoing acceleration corresponding to the slow-down based on the additional acceleration, to obtain an updated acceleration. For example, if the acceleration corresponding to the slow-down is a₀, and the additional acceleration is a₀, the updated acceleration is a₂=a₀+a₁. (Directions of the three accelerations a₀, a₁, and a₂ are the same).

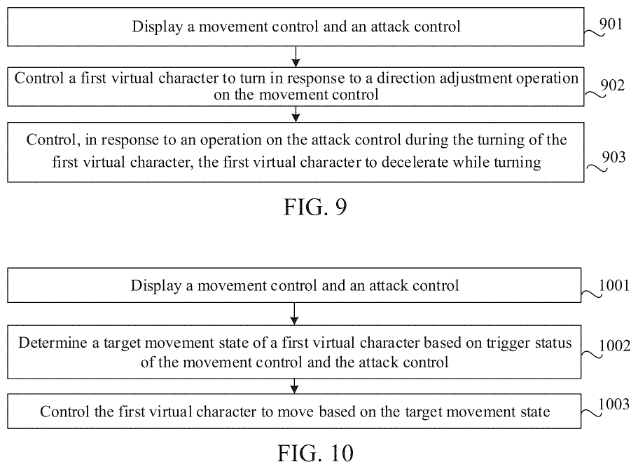

Further, the client controls the first virtual character to slow down based on the updated acceleration, until the first virtual character stops moving. The foregoing updated acceleration is higher than the foregoing acceleration corresponding to the slow-down. To be specific, after the first operation stops, a user can control the first virtual character to quickly stop moving through the second operation on the attack control. For example, as shown in FIG. 8, a user interface includes a movement control 81 and an attack control 82. When it is detected that a first operation on the movement control 81 disappears, the client controls a first virtual character 83 to slow down. Further, when a second operation on the attack control 82 is detected, the client controls the first virtual character 83 to quickly stop moving.

In a possible implementation, after updating the foregoing acceleration corresponding to the slow-down, the client directly replaces the acceleration corresponding to the slow-down with the additional acceleration, to obtain the updated acceleration. In another possible implementation, after updating the foregoing acceleration corresponding to the slow-down, the client superimposes the additional acceleration on the acceleration corresponding to the slow-down, to obtain the updated acceleration.

During slow-down of a virtual character, a slow-down process of the virtual character is shortened based on an attack operation, and a method for shortening time required for the virtual character to stop moving is provided, so that game operations can be expanded, thereby improving playability of a game. In the method provided in this application, the virtual character can perform an attack operation during movement (in other words, move and attack simultaneously in the virtual environment), and a movement speed of the virtual character can be affected by the attack operation. In this method, the virtual character can perform an attack operation during the slow-down. The movement speed of the virtual character decreasing, provides a player with more reaction time to determine a casting direction of the attack operation, so that accuracy of the attack operation of the virtual character can be improved. In addition, during the attack operation, the virtual character can slow down in the virtual environment, so that a movement position of the virtual character in the virtual environment is difficult to be predicted by another user. This helps the virtual character avoid attacks in the virtual environment, so that a survival probability of the virtual character in game battling, thereby speeding up a game process, shortening time of the game battling, and reducing energy consumption of the terminal device.

In conclusion, in the technical solutions provided in embodiments of this application, during movement of a virtual character, the virtual character is controlled to speed up through an operation on an attack control, so that movement manners of the virtual character are enriched. In addition, when the virtual character is controlled to quickly stop moving, there is need to provide a specific control, and the virtual character can be controlled to quickly stop moving based on triggering of a combination of existing controls. In this way, functions of existing movement controls and skill controls can be enriched, an interface layout can be simplified, and unwanted operations caused by an excessively complex interface layout can be reduced.

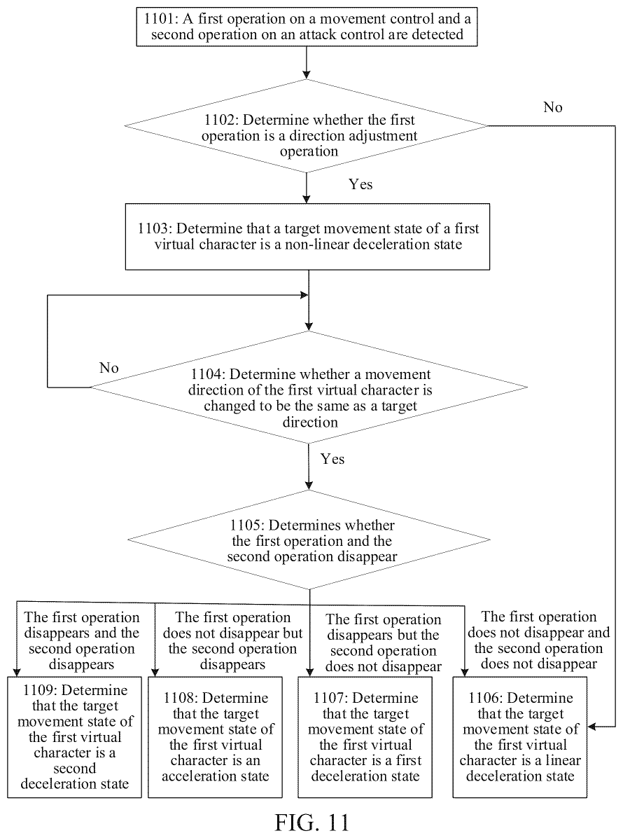

FIG. 9 is a flowchart of a virtual character control method according to another embodiment of this application. The method is performed by the terminal device 10 of the virtual character control system shown in FIG. 1. For example, operations may be performed by the client of the application in the terminal device 10. The method may include at least one operation in the following operations (901-903):

Operation 901: Display a movement control and an attack control.

This operation is the same as or similar to operation 301 in the foregoing embodiment. For details, reference may be made to the foregoing description. Details are not described herein again.

Operation 902: Control a first virtual character to turn in response to a direction adjustment operation on the movement control.

The turning is a movement manner in which a movement direction changes during movement of the first virtual character. In some embodiments, a movement angular velocity is constant during the turning of the first virtual character, or a movement angular velocity dynamically changes during the turning of the first virtual character. In some embodiments, a movement angular velocity during the turning of the first virtual character is related to whether an attack operation is performed during the turning of the first virtual character.

In some embodiments, after displaying the foregoing movement control, the client detects the movement control. When the direction adjustment operation on the movement control is detected, the client controls the first virtual character to turn.

In some embodiments, the client obtains a target direction indicated by the direction adjustment operation as well as a turning acceleration, turning angular velocity, and maximum turning speed corresponding to the turning. The client controls the first virtual character to turn based on the turning acceleration, turning angular velocity, and maximum turning speed corresponding to the turning. The client controls a movement direction of the first virtual character to change toward the target direction during the turning.

The foregoing turning may also be referred to as curvilinear movement.

Operation 903: Control, in response to an operation on the attack control during the turning of the first virtual character, the first virtual character to decelerate while turning.

In this embodiment of this application, after displaying the foregoing attack control, the client detects the attack control, and when the operation on the attack control is detected and the first virtual character is in a turning process, the client controls the first virtual character to decelerate while turning. In some embodiments, the client obtains a target direction indicated by the direction adjustment operation as well as a turning acceleration, turning angular velocity, and maximum turning speed corresponding to the deceleration while turning. Further, the client controls, based on the turning acceleration, turning angular velocity, and maximum turning speed corresponding to the deceleration while turning, the first virtual character to decelerate while turning, and controls a movement direction of the first virtual character to change toward the target direction during the deceleration while turning.

An orientation change speed of the first virtual character is higher than a movement direction change speed during the deceleration while turning. In some embodiments, the first virtual character corresponds to a representation orientation and a logical orientation. The representation orientation of the first virtual character is an orientation of the first virtual character, and the logical orientation of the first virtual character is the same as the movement direction of the first virtual character. The orientation of the first virtual character may be understood as an orientation of the first virtual character displayed in a user interface.

In some embodiments, the foregoing movement control alternatively corresponds to a non-direction-adjustment operation. When the non-direction-adjustment operation on the movement control is detected, the client controls the first virtual character to move linearly. Further, the client controls the first virtual character to decelerate linearly if the operation on the attack control is detected during the linear movement of the first virtual character. For details of the operation, reference is made to the following embodiments. When the first virtual character decelerates linearly, there is no need to change movement manners of the first virtual character during the decelerating, so that processing logic of the terminal device can be simplified.

The foregoing operation on the attack control may be referred to as a second operation on the attack control. The foregoing direction adjustment operation and non-direction-adjustment operation on the movement control may be collectively referred to as a first operation on the movement control.

In conclusion, in the technical solutions provided in embodiments of this application, a virtual character is controlled to turn through a direction adjustment operation on a movement control, and during the turning of the virtual character, the virtual character is controlled, through an operation on an attack control, to decelerate while turning, so that movement manners of the virtual character are enriched. In addition, when the virtual character is controlled to decelerate while turning, there is need to provide a specific control, and the virtual character can be controlled, based on triggering of a combination of existing controls, to decelerate while turning. In this way, functions of existing movement controls and skill controls can be enriched, an interface layout can be simplified, and unwanted operations caused by an excessively complex interface layout can be reduced.

A method for controlling the first virtual character in this application is described below.

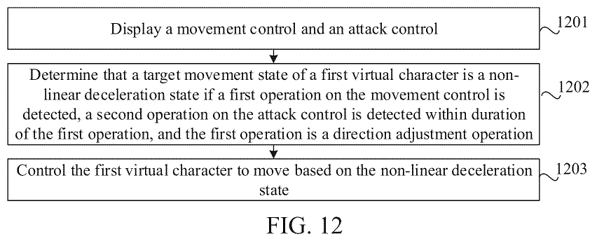

FIG. 10 is a flowchart of a virtual character control method according to another embodiment of this application. The method is performed by the terminal device 10 of the virtual character control system shown in FIG. 1, and operations may be performed by the client of the application in the terminal device 10. The method may include at least one operation in the following operations (1001-1003):

Operation 1001: Display a movement control and an attack control.

In some embodiments, a user interface further includes a first virtual character and a rush energy prompt bar and a movement speed indication icon that correspond to the first virtual character.

Operation 1002: Determine a target movement state of the first virtual character based on trigger status of the movement control and the attack control.

In this embodiment of this application, after displaying the foregoing movement control and the foregoing attack control, the client detects the movement control and the attack control, and then determines the target movement state of the first virtual character based on the trigger status of the movement control and the attack control. The target movement state is a movement state which the first virtual character is to enter, and the trigger status is for indicating changes of trigger operations on the controls. For example, a trigger operation being present from none is a type of trigger status; a trigger operation disappearing from being present another type of trigger status; a trigger operation changing from a first operation type to a second operation type is still another type of trigger status; and the like.

In some embodiments, the movement control corresponds to a plurality of trigger operations. For example, a user controls the first virtual character to move toward different direction through different trigger operations; a user controls the first virtual character to move at different speeds through different trigger operations; or a user controls the first virtual character to move toward different direction at different speeds through different trigger operations.

In some embodiments, the attack control corresponds to one or more trigger operations. In a possible implementation, the attack control corresponds to a trigger operation. The user controls, through the trigger operation, the first virtual character to perform an attack action and adjusts the target movement state of the first virtual character. In another possible implementation, the attack control corresponds to a plurality of trigger operations. The user controls, through different trigger operations, the first virtual character to perform different attack actions. In this case, the plurality of trigger operations include a target trigger operation. The user adjusts the target movement state of the first virtual character through the target trigger operation, and the target trigger operation does not correspond to a skill. In other words, the user can only adjust the target movement state of the first virtual character through the target trigger operation, but cannot control the first virtual character to perform an attack action.

In this embodiment of this application, the foregoing target movement state includes a non-linear deceleration state, a linear deceleration state, an acceleration state, a first deceleration state, and a second deceleration state. The linear deceleration state, the first deceleration state, and the second deceleration state are three different deceleration states, and the first virtual character moves in different manners in different deceleration states.

In this embodiment of this application, the client determines the target movement state of the first virtual character based on a first operation on the movement control and a second operation on the attack control. The first operation may be a drag operation. For example, in this embodiment of this application, the user controls the first virtual character to move by dragging a joystick. Similarly, the second operation may be any operation, for example, a click/tap operation, double click/double tap operation, a hard press/touch operation, or a slide operation, which is not limited in embodiments of this application. In some embodiments, the first operation and the second operation may be the same or different, which is not limited in embodiments of this application.

In some embodiments, the client determines that the target movement state of the first virtual character is the non-linear deceleration state if the first operation on the movement control is detected by the client, the second operation on the attack control is detected within duration of the first operation, and the first operation is a direction adjustment operation. For example, the foregoing direction adjustment operation is the drag operation on the joystick, a drag direction is different from a current movement direction of the first virtual character, and the second operation is the click/tap operation. In other words, the client determines that the target movement state of the first virtual character is the non-linear deceleration state when the drag operation on the movement control is detected and the click/tap operation on the attack control is detected within duration of the drag operation. In this embodiment of this application, the foregoing non-linear deceleration state is also referred to as a drift state or a turning state.

In some embodiments, the client determines that the target movement state of the first virtual character is the linear deceleration state if the first operation on the movement control is detected, the second operation on the attack control is detected within duration of the first operation, and the first operation is not a direction adjustment operation. For example, the foregoing first operation is the drag operation on the joystick, a drag direction is the same as the current movement direction of the first virtual character, and the second operation is the click/tap operation. In other words, the client determines that the target movement state of the first virtual character is the linear deceleration state when the drag operation on the movement control is detected and the click/tap operation on the attack control is detected within duration of the drag operation.

In some embodiments, the client determines that the target movement state of the first virtual character is the acceleration state if the first operation on the movement control is detected and no second operation on the attack control is detected within duration of the first operation. For example, the foregoing first operation is the drag operation on the joystick, and the foregoing second operation is any operation. In other words, the client determines that the target movement state of the first virtual character is the acceleration state when the drag operation on the joystick is detected and no operation on the attack control is detected within duration of the drag operation. Certainly, in an exemplary embodiment, the first operation and the second operation may be the same or different, which is not limited in embodiments of this application.

In some embodiments, the client determines that the target movement state of the first virtual character is the first deceleration state if the first operation on the movement control is detected and the second operation on the attack control is detected within first duration after the first operation disappears. For example, the foregoing first operation is the drag operation on the joystick, and the second operation is the press/touch operation. In other words, the client determines that the target movement state of the first virtual character is the first deceleration state when it is detected that the drag operation on the joystick disappears and the press/touch operation on the attack control is detected within first duration. In some embodiments, duration in which the first virtual character is in the first deceleration state is equal to press/touch duration of the press/touch operation. For example, a start moment of the first deceleration state is a start moment of the press/touch operation, and an end moment of the first deceleration state is an end moment of the press/touch operation. In some embodiments, in the first deceleration state, a minimum speed of the first virtual character is zero, and the foregoing first duration is shorter than or equal to duration required for a speed of the first virtual character decreasing to zero. Because the speed of the first virtual character cannot be guaranteed to be constant, the foregoing first duration is also flexible and variable. For example, when at a specific moment, it is determined that the target movement state of the first virtual character is the second deceleration state, duration required for the speed of the first virtual character decreasing to zero is determined based on the speed of the first virtual character at the moment, and then the foregoing first duration is determined based on the duration. Certainly, in an exemplary embodiment, the first operation and the second operation may be the same or different, which is not limited in embodiments of this application.

In some embodiments, the client determines that the target movement state of the first virtual character is the second deceleration state if the first operation on the movement control is detected and no second operation on the attack control is detected after the first operation disappears. For example, the foregoing first operation is the drag operation on the joystick, and the second operation is any operation. In other words, the client determines that the target movement state of the first virtual character is the second deceleration state when no operation on the attack control is detected after it is detected that the drag operation on the joystick disappears. Certainly, in an exemplary embodiment, the first operation and the second operation may be the same or different, which is not limited in embodiments of this application.

In this embodiment of this application, because the attack control can control the first virtual character to perform an attack action, when the user can control, through the second operation, the first virtual character to perform an attack action, the client increases rush energy corresponding to the first virtual character when the second operation on the attack control is detected, and the client controls the first virtual character to speed up when the rush energy satisfies a first condition.

For example, correspondences between the target movement state and the operations are shown below in Table 1.

TABLE 1
Correspondences between target movement state and operations

| Target | | | |
|---|---|---|---|
| movement | | Second | |
| state | First operation | operation | Speed up |
| Non-linear | Present, a direction | Present | Accumulate rush |
| movement | adjustment | | energy, and control |
| state | operation | | a first virtual |
| Linear | Present, not a | Present | character to speed |
| movement | direction | | up when the rush |
| state | adjustment | | energy satisfies a |
| | operation | | first condition |
| First | Not present | Present | |
| deceleration | | | |
| state | | | |
| Acceleration | Present | Not present | Not attack |
| state | | | |
| Second | Not present | Not present | Not attack |
| deceleration | | | |
| state | | | |

In this embodiment of this application, after the foregoing speed-up ends, the client continues to control the first virtual character to move in a previous movement state. The previous movement state is a movement state of the first virtual character when the rush energy satisfies the first condition.

In this embodiment of this application, the first virtual character corresponds to a virtual vehicle, and the client renders a movement effect of the virtual vehicle to display a movement state of the first virtual character. When the first virtual character moves by using the virtual vehicle, drifting (the non-linear deceleration state), slow braking (the linear deceleration state), accelerating, fast braking (the first deceleration state), and ordinary braking (the second deceleration state) can be achieved, and the inertia of the virtual vehicle during the movement is taken into consideration. In this way, reality of the movement of the virtual vehicle when carrying the first virtual character. In a possible implementation, there is a binding relationship between the first virtual character and the virtual vehicle. To be specific, when the user controls the first virtual character to enter a battle, the first virtual character is automatically carried by the virtual vehicle, and this may be understood as that the virtual vehicle is part of the first virtual character. In another possible implementation, there is a non-binding relationship between the first virtual character and the virtual vehicle. To be specific, after the user controls the first virtual character to enter a battle, in response to a summoning operation on the virtual vehicle, the client summons the virtual vehicle to carry the first virtual character.

Operation 1003: Control the first virtual character to move based on the target movement state.

In this embodiment of this application, after determining the target movement state of the first virtual character, the client controls the first virtual character to move based on the target movement state. In some embodiments, the client obtains a movement parameter corresponding to the target movement state, and then controls the first virtual character to move based on the movement parameter. In some embodiments, the foregoing movement parameter is obtained based on a pre-configured parameter set.

In a possible implementation, correspondences between the target movement state and the movement parameters are recorded in the foregoing pre-configured parameter set. In some embodiments, after obtaining the target movement state, the client directly obtains the movement parameter corresponding to the target movement state from the pre-configured parameter set, and this operation is simple and efficient.

In another possible implementation, correspondences between the operations and the movement parameter and correspondences the target movement state and calculation rules are recorded in the foregoing pre-configured parameter set. In some embodiments, after obtaining the target movement state, the client obtains the movement parameter corresponding to a target operation and the calculation rule corresponding to the target movement state from the pre-configured parameter set, and then calculates the movement parameter based on the calculation rule, to obtain the movement parameter corresponding to the target movement state. According to this method, parameter configuration is flexible, movement parameters corresponding to different target movement states can be obtained through different combinations of the same parameters, so that movement manners of the first virtual character can be enriched, and quantity requirements of the parameter configuration can be reduced. The foregoing target operation may include the first operation on the movement control and the first operation being a direction adjustment operation, the first operation on the movement control and the first operation being not a direction adjustment operation, the first operation on the movement control disappearing, and the second operation on the attack control.

In conclusion, in the technical solutions provided in embodiments of this application, a movement state of a virtual character to enter is determined based on trigger status of a movement control and an attack control, and different movement states correspond to different movement manners, so that the movement manners of the virtual character are enriched, and strategic and flexible control of virtual character can be improved.

In addition, a target movement state of the virtual character is determined based on an operation on the movement control and an operation on the attack control, and the target movement state is any one of a non-linear deceleration state, a linear deceleration state, an acceleration state, a first deceleration state, and a second deceleration state, so that movement flexibility of the virtual character can be improved.

Moreover, compared to a fixed movement animation in related art, controlling the virtual character to move based on a movement parameter allows more flexible and realistic control for movement of the virtual character.

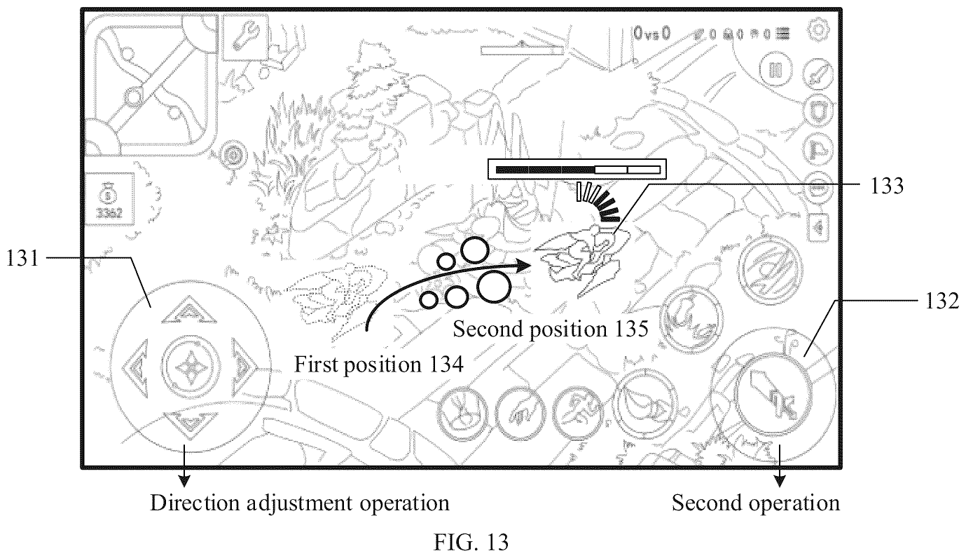

In some embodiments, different target movement states may be switched between each other. For example, as shown in FIG. 11, specific operations are as follows:

Operation 1101: A first operation on a movement control and a second operation on an attack control are detected by a client.

Operation 1102: The client determines whether the first operation is a direction adjustment operation. If the first operation is the direction adjustment operation, operations 1103 to 1105 are performed. If the first operation is not the direction adjustment operation, operation 1106 is performed.

Operation 1103: The client determines that a target movement state of a first virtual character is a non-linear deceleration state.

Operation 1104: The client determines whether a movement direction of the first virtual character is changed to be the same as a target direction. If the movement direction of the first virtual character is changed to be the same as the target direction, operation 1106 is performed. If the movement direction of the first virtual character is not changed to be the same as the target direction, operation 1104 continues to be performed.

Operation 1105: The client determines whether the first operation and the second operation disappear. If the first operation does not disappear and the second operation does not disappear, operation 1106 is performed. If the first operation disappears but the second operation does not disappear, operation 1107 is performed. If the first operation does not disappear but the second operation disappears, operation 1108 is performed. If the first operation disappears and the second operation disappears, operation 1109 is performed.

Operation 1106: The client determines that the target movement state of the first virtual character is a linear deceleration state.

Operation 1107: The client determines that the target movement state of the first virtual character is a first deceleration state.

Operation 1108: The client determines that the target movement state of the first virtual character is an acceleration state.

Operation 1109: The client determines that the target movement state of the first virtual character is a second deceleration state.

In this embodiment of this application, a deceleration efficiency corresponding to the first deceleration state is greater than a deceleration efficiency corresponding to the second deceleration state, and the deceleration efficiency corresponding to the second deceleration state is greater than a deceleration efficiency corresponding to the linear deceleration state. For example, the first deceleration state is referred to as a fast braking state, the second deceleration state is referred to as an ordinary braking state, and the linear deceleration state is referred to as a slow braking state.

Movement manners corresponding to different target movement states are described below.

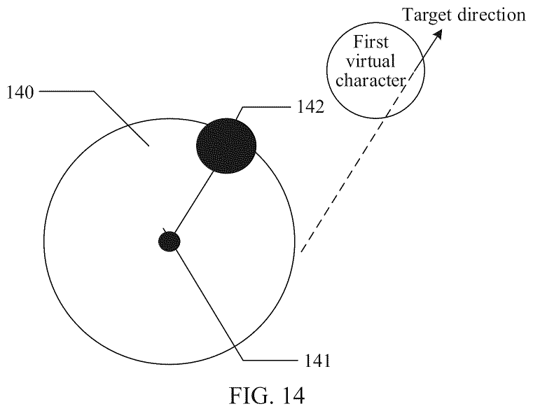

FIG. 12 is a flowchart of a virtual character control method according to another embodiment of this application. The method is performed by the terminal device 10 of the virtual character control system shown in FIG. 1, and operations may be performed by the client of the application in the terminal device 10. The method may include at least one operation in the following operations (1201-1203):

Operation 1201: Display a movement control and an attack control. The foregoing operation 1201 is similar to operation 1001 in the embodiment of FIG. 10. For details, reference is made to the embodiment of FIG. 10. Details are not described herein.

Operation 1202: Determine that a target movement state of a first virtual character is a non-linear deceleration state if a first operation on the movement control is detected, a second operation on the attack control is detected within duration of the first operation, and the first operation is a direction adjustment operation.

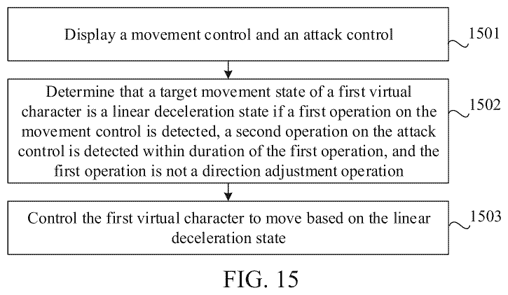

In some embodiments, the non-linear deceleration state is a movement state in which deceleration is performed during curvilinear movement. As shown in FIG. 13, when a direction adjustment operation on a movement control 131 and a second operation on an attack control 132 are detected, the client controls a first virtual character 133 to move from a first position 134 to a second position 135 in a manner of deceleration while turning.

Operation 1203: Control the first virtual character to move based on the non-linear deceleration state.

In an exemplary embodiment, the foregoing operation 1203 includes at least one of the following operations:

1: Obtain a target direction indicated by the direction adjustment operation on the movement control.

In this embodiment of this application, when it is determined that the target movement state of the first virtual character is the non-linear deceleration state, the client obtains the target direction indicated by the direction adjustment operation based on the foregoing direction adjustment operation. The target direction is for indicating a final movement direction of the first virtual character in the non-linear deceleration state.

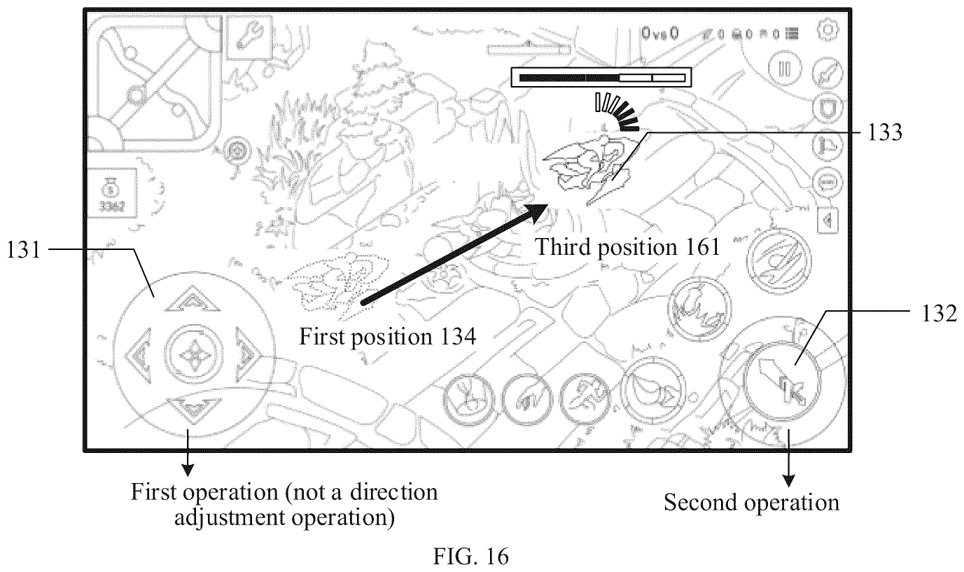

In a possible implementation, the foregoing direction adjustment operation is a drag operation on a joystick, and the client determines the foregoing target direction based on a drag manner of the drag operation. For example, as shown in FIG. 14, a target direction is from a center point 141 of a movement control 140 to a final position 142 of a drag operation.

In another possible implementation, the foregoing direction adjustment operation is a slide operation on the movement control, and the client determines the foregoing target direction based on a start position and an end position of the slide operation. In some embodiments, using a connecting line between the start position and a center point of the movement control as a first connecting line and a connection between the end position and the center point of the movement control as a second connecting line, the client determines an angle between the first connecting line and the second connecting line as a transformation angle, and determines the foregoing target direction through rotating a current direction of the first virtual character by the transformation angle. A rotation direction corresponding to the current direction is the same as a slide direction of the slide operation.

2: Obtain a movement parameter corresponding to the non-linear deceleration state.

In this embodiment of this application, after determining that the target movement state of the first virtual character is the non-linear deceleration state, the client obtains the movement parameter corresponding to the non-linear deceleration state. The movement parameter includes a turning acceleration, turning speed, and turning angular velocity corresponding to the non-linear deceleration state.

In a possible implementation, the foregoing movement parameter corresponds only to the target movement state. In some embodiments, after determining that the target movement state of the first virtual character is the non-linear deceleration state, the client directly obtains the movement parameter corresponding to the non-linear deceleration state from a pre-configured parameter set.

In another possible implementation, the foregoing movement parameter is related to the target movement state and the first operation. In some embodiments, after determining that the target movement state of the first virtual character is the non-linear deceleration state, the client obtains a basic movement parameter corresponding to the non-linear deceleration state. The basic movement parameter includes a basic turning acceleration, a basic turning speed, and a basic turning angular velocity of the first virtual character. Further, the client determines an offset movement parameter corresponding to the non-linear deceleration state based on attribute information of the direction adjustment operation. The offset movement parameter includes an offset turning acceleration, an offset turning speed, and an offset turning angular velocity of the first virtual character. Then, the client determines the movement parameter corresponding to the non-linear deceleration state based on the basic movement parameter and the offset movement parameter. In some embodiments, the foregoing basic movement parameter is obtained from a pre-configured parameter set.

In some embodiments, different types of direction adjustment operations have different attribute information. For example, if the direction adjustment operation is a slide operation, the attribute information of the direction adjustment operation includes a sliding speed. The client determines the offset movement parameter based on the sliding speed, and the sliding speed is in positive correlation with a value of the offset movement parameter. In other words, a higher sliding speed indicates a larger offset value corresponding to the offset movement parameter. Alternatively, if the direction adjustment operation is a click/tap operation, the attribute information of the direction adjustment operation includes press/touch pressure. The client determines the offset movement parameter based on the press/touch pressure, and the press/touch pressure is in positive correlation with a value of the offset movement parameter. In other words, a higher press/touch pressure indicates a larger offset value corresponding to the offset movement parameter. For example, if the direction adjustment operation is a multi-click/multi-tap operation, the attribute information of the direction adjustment operation includes a quantity of clicks/taps. The client determines the offset movement parameter based on the quantity of clicks/taps, and the quantity of clicks/taps is in positive correlation with a value of the offset movement parameter. In other words, a larger quantity of clicks/taps indicates a larger offset value corresponding to the offset movement parameter.

In still another possible implementation, the foregoing movement parameter is related to the target movement state and an operation basis for determining the target movement state. For example, the operation basis of the non-linear deceleration state includes the direction adjustment operation on the movement control and the second operation on the attack control. When obtaining the movement parameter, the client obtains a parameter corresponding to the direction adjustment operation and a parameter corresponding to the second operation and obtains a calculation rule corresponding to the non-linear deceleration state, and then calculates the parameter corresponding to the direction adjustment operation and the parameter corresponding to the second operation based on the calculation rule to obtain the foregoing movement parameter. In some embodiments, the parameter corresponding to the foregoing direction adjustment operation and the parameter corresponding to the foregoing second operation are obtained from a pre-configured parameter set.

3: The client controls the first virtual character to move curvilinearly based on the turning acceleration, turning speed, and turning angular velocity corresponding to the non-linear deceleration state, and during the curvilinear movement, controls a movement direction of the first virtual character to change toward the target direction from the current direction.

In some embodiments, the turning acceleration is for representing a value change speed of a speed of the first virtual character in the non-linear deceleration state; the turning speed is a value of a minimum speed that the first virtual character can reach in the non-linear deceleration state; and the turning angular velocity is for representing a directional change speed of the speed of the first virtual character.

In this embodiment of this application, during the curvilinear movement, the movement direction of the first virtual character is adjusted based on the turning angular velocity until the movement direction of the first virtual character is the target direction. In addition, the speed of the first virtual character is adjusted based on the turning acceleration until the speed of the first virtual character is the turning speed.

In this embodiment of this application, during the curvilinear movement, an orientation of the first virtual character is also controlled to change, to enable the orientation of the first virtual character is always the same as the direction of the speed. For example, in this embodiment of this application, the orientation of the first virtual character includes a logical orientation and a representation orientation. The logical orientation is an orientation that the first virtual character is to show theoretically, and the representation orientation is an actual orientation of the first virtual character displayed on a user interface. To create a drift effect, in the non-linear deceleration state (that is, a turning state), a change of the representation orientation of the first virtual character during the turning is faster than a change of the logical orientation. The client controls the movement direction of the first virtual character based on the logical orientation and controls a character turning direction of the first virtual character based on the representation orientation, to create a drifting effect. In a possible implementation, the foregoing turning angular velocity includes two turning angular velocities, namely, a first turning angular velocity and a second turning angular velocity. The logical orientation of the first virtual character is controlled based on the first turning angular velocity, and the representation orientation of the first virtual character is controlled based on the second turning angular velocity. The first turning angular velocity is lower than the second turning angular velocity. In another possible implementation, the foregoing turning angular velocity only includes one turning angular velocity. Based on the turning angular velocity, the client controls the logical orientation to change after controlling the representation orientation to change. For example, after determining that the target movement state of the first virtual character is the non-linear deceleration state, the representation orientation of the first virtual character is controlled to change in an i^{th} frame, and the logical orientation of the first virtual character is controlled to change in an (i+1)^{th} frame. i is any numerical value, which is not limited in embodiments of this application.

In conclusion, in the technical solutions provided in embodiments of this application, a virtual character is controlled to move in a non-linear deceleration state through a direction adjustment operation on a movement control and an operation on an attack control, so that movement manners of the virtual character are enriched. In addition, when a target movement state of the virtual character is controlled to switch to the non-linear deceleration state, there is need to provide a specific control, and the virtual character can be controlled to enter the non-linear deceleration state based on existing controls, to implement switching of the non-linear deceleration state through a combination of the controls. In this way, functions of existing movement controls and skill controls can be enriched, an interface layout can be simplified, and unwanted operations caused by an excessively complex interface layout can be reduced.

Moreover, when determining the movement parameters of the non-linear deceleration state, based on the basic movement parameter, adjustments are made based on the offset movement parameter and the basic movement parameter, to avoid unrealistic movement parameter of the non-linear deceleration state.

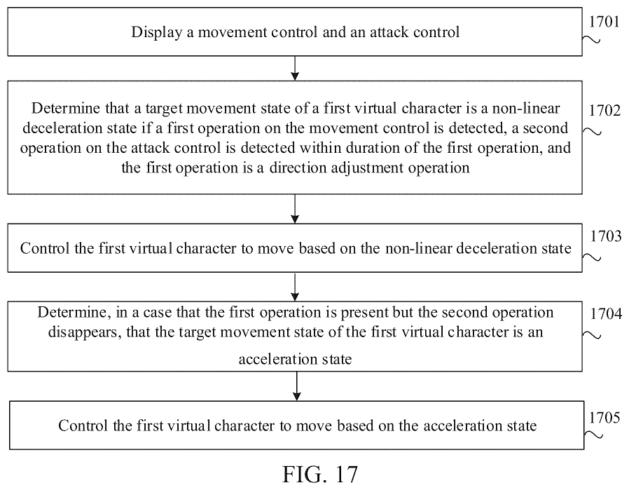

FIG. 15 is a flowchart of a virtual character control method according to another embodiment of this application. The method is performed by the terminal device 10 of the virtual character control system shown in FIG. 1, and operations may be performed by the client of the application in the terminal device 10. The method may include at least one operation in the following operations (1501-1503):

Operation 1501: Display a movement control and an attack control. The foregoing operation 1501 is similar to operation 1001 in the embodiment of FIG. 10. For details, reference is made to the embodiment of FIG. 10. Details are not described herein.

Operation 1502: Determine that a target movement state of a first virtual character is a linear deceleration state if a first operation on the movement control is detected, a second operation on the attack control is detected within duration of the first operation, and the first operation is not a direction adjustment operation.

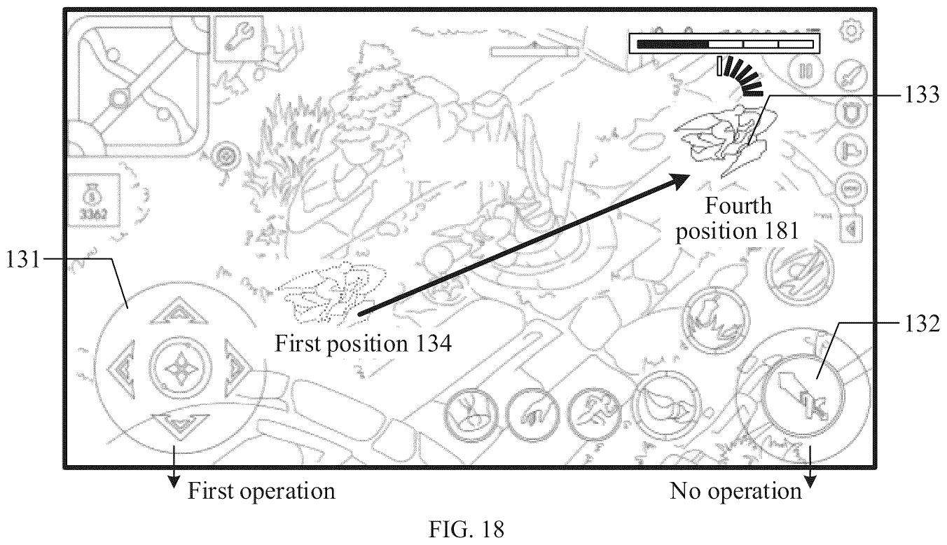

In this embodiment of this application, the linear deceleration state is a movement state in which slow deceleration is performed during linear movement. For example, as shown in FIG. 16, when a first operation (not a direction adjustment operation) on a movement control 131 and a second operation on an attack control 132 are detected, the client controls a first virtual character 133 to move from a first position 134 to a third position 161 in a linear deceleration manner.

Operation 1503: Control the first virtual character to move based on the linear deceleration state. In an exemplary embodiment, the foregoing operation 1503 includes at least one of the following operations:

1: Obtain a movement parameter corresponding to the linear deceleration state. In this embodiment of this application, after determining that the target movement state of the first virtual character is the linear deceleration state, the client obtains the movement parameter corresponding to the linear deceleration state. The movement parameter includes a linear speed and a linear acceleration of the first virtual character.

In a possible implementation, the foregoing movement parameter corresponds only to the target movement state. In some embodiments, after determining that the target movement state of the first virtual character is the linear deceleration state, the client directly obtains the movement parameter corresponding to the linear deceleration state from a pre-configured parameter set.

In another possible implementation, the foregoing movement parameter is related to the target movement state and the first operation. In some embodiments, after determining that the target movement state of the first virtual character is the linear deceleration state, the client obtains a basic movement parameter corresponding to the linear deceleration state. The basic movement parameter includes a basic linear acceleration and a basic linear speed of the first virtual character. Further, the client determines an offset movement parameter corresponding to the linear deceleration state based on attribute information of the first operation (not the direction adjustment operation). The offset movement parameter includes an offset linear acceleration and an offset linear speed of the first virtual character. Then, the client determines the movement parameter corresponding to the linear deceleration state based on the basic movement parameter and the offset movement parameter. In some embodiments, the foregoing basic movement parameter is obtained from a pre-configured parameter set. In some embodiments, attribute information of different types of first operations are different. Details are similar to the attribute information of the foregoing direction adjustment operation, which are not described herein.

In still another possible implementation, the foregoing movement parameter is related to the target movement state and an operation basis for determining the target movement state. For example, the operation basis of the linear deceleration state includes the first operation on the movement control and the second operation on the attack control. When obtaining the movement parameter, the client obtains a parameter corresponding to the first operation and a parameter corresponding to the second operation and obtains a calculation rule corresponding to the linear deceleration state, and then calculates the parameter corresponding to the first operation and the parameter corresponding to the second operation based on the calculation rule to obtain the foregoing movement parameter. In some embodiments, the parameter corresponding to the foregoing first operation and the parameter corresponding to the foregoing second operation are obtained from a pre-configured parameter set.

Using the foregoing linear acceleration as an example, in obtaining the linear acceleration, a first acceleration and a second acceleration are obtained. The first acceleration is an acceleration corresponding to an acceleration state, and the second acceleration is an acceleration corresponding to the operation on the attack control. Further, the linear acceleration of the first virtual character is determined based on the first acceleration and the second acceleration. In this embodiment of this application, the client determines the linear acceleration of the first virtual character based on the first acceleration and the second acceleration as well as the calculation rule corresponding to the linear deceleration state.

In this embodiment of this application, the foregoing first acceleration may also be referred to as an acceleration corresponding to the first operation on the movement control.

2: Control the first virtual character to move based on the linear acceleration and the linear speed.

In some embodiments, the linear acceleration is for representing a value change speed of a speed of the first virtual character in the linear deceleration state, and the linear speed is a value of a minimum speed that the first virtual character can reach in the linear deceleration state. In some embodiments, the linear speed is zero.

In this embodiment of this application, the first virtual character is controlled to move at a change speed in a current direction based on the linear acceleration until the speed of the first virtual character is changed to the linear speed. Then, the first virtual character is controlled to continue to move uniformly in the current direction based on the linear speed.

In some embodiments, the current direction of the first virtual character may be a previous movement direction of the first virtual character or an orientation of the first virtual character, which is not limited in embodiments of this application.

In conclusion, in the technical solutions provided in embodiments of this application, a virtual character is controlled to move in a linear deceleration state through a non-direction-adjustment operation on a movement control and an operation on an attack control, so that movement manners of the virtual character are enriched.

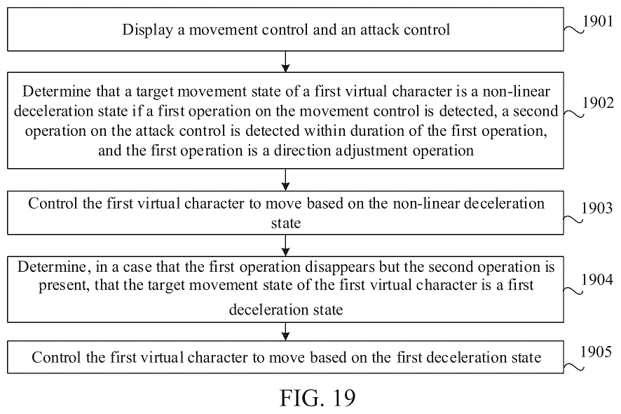

FIG. 17 is a flowchart of a virtual character control method according to another embodiment of this application. The method is performed by the terminal device 10 of the virtual character control system shown in FIG. 1, and operations may be performed by the client of the application in the terminal device 10. The method may include at least one operation in the following operations (1701-1705):

Operation 1701: Display a movement control and an attack control.

Operation 1702: Determine that a target movement state of a first virtual character is a non-linear deceleration state if a first operation on the movement control is detected, a second operation on the attack control is detected within duration of the first operation, and the first operation is a direction adjustment operation.

Operation 1703: Control the first virtual character to move based on the non-linear deceleration state. The foregoing operation 1701 to operation 1703 are similar to operation 1201 to operation 1203 in the embodiment of FIG. 12. For details, reference is made to the embodiment of FIG. 12. Details are not described herein.

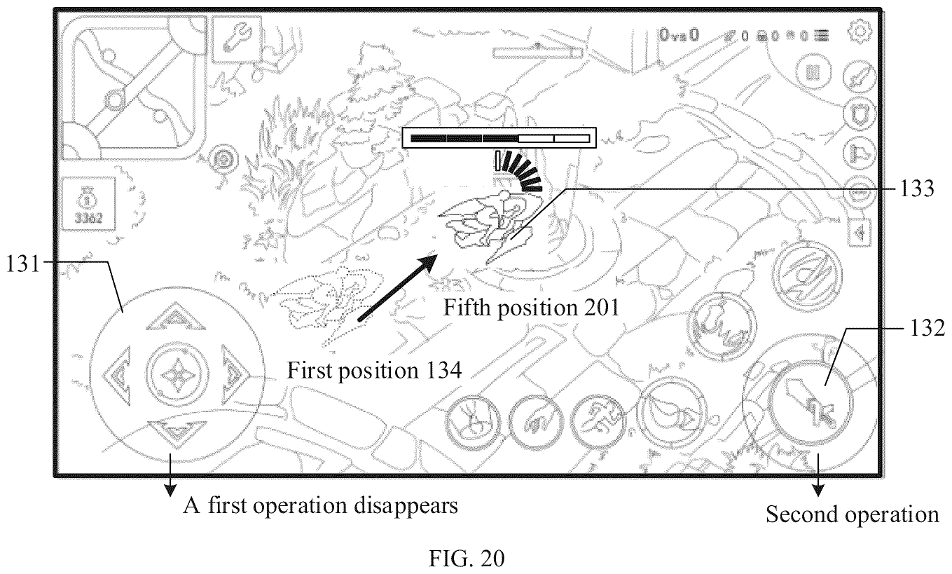

Operation 1704: Determine, when the first operation is present but the second operation disappears, that the target movement state of the first virtual character is an acceleration state. In this embodiment of this application, the acceleration state is an accelerated movement state of the first virtual character. For example, as shown in FIG. 18, when a first operation on a movement control 131 is detected and no operation on an attack control 132 is detected, the client controls a first virtual character 133 to move from a first position 134 to a fourth position 181 in an acceleration manner.

Operation 1705: Control the first virtual character to move based on the acceleration state. In an exemplary embodiment, the foregoing operation 1705 includes at least one of the following operations:

1: Obtain a movement parameter corresponding to the acceleration state.

In this embodiment of this application, after determining that the target movement state of the first virtual character is the acceleration state, the client obtains the movement parameter corresponding to the acceleration state. The movement parameter includes a first acceleration and a maximum speed of the first virtual character, and the first acceleration is an acceleration corresponding to the acceleration state.

In a possible implementation, the foregoing movement parameter corresponds only to the target movement state. In some embodiments, after determining that the target movement state of the first virtual character is the acceleration state, the client directly obtains the movement parameter corresponding to the acceleration state from a pre-configured parameter set.

In another possible implementation, the foregoing movement parameter is related to the target movement state and the first operation. In some embodiments, after determining that the target movement state of the first virtual character is the acceleration state, the client obtains a basic movement parameter corresponding to the acceleration state. The basic movement parameter includes a basic first acceleration and a basic maximum speed of the first virtual character. Further, the client determines an offset movement parameter corresponding to the acceleration state based on attribute information of the first operation. The offset movement parameter includes an offset first acceleration and an offset maximum speed of the first virtual character. Then, the client determines the movement parameter corresponding to the acceleration state based on the basic movement parameter and the offset movement parameter. In some embodiments, the foregoing basic movement parameter is obtained from a pre-configured parameter set. In some embodiments, attribute information of different types of first operations are different. Details are similar to the attribute information of the foregoing direction adjustment operation, which are not described herein.

In still another possible implementation, the foregoing movement parameter is related to the target movement state and an operation basis for determining the target movement state. For example, the operation basis of the acceleration state includes the first operation on the movement control. When obtaining the movement parameter, the client obtains a parameter corresponding to the first operation and a calculation rule corresponding to the acceleration state, and then calculates the parameter corresponding to the first operation based on the calculation rule to obtain the foregoing movement parameter. In some embodiments, the parameter corresponding to the foregoing first operation is obtained from a pre-configured parameter set.

2: Control the first virtual character to move based on the first acceleration and the maximum speed.

In some embodiments, the first acceleration is for representing a value change speed of a speed of the first virtual character in the acceleration state, and the maximum speed is a value of a maximum speed that the first virtual character can reach in the acceleration state.

In this embodiment of this application, the first virtual character is controlled to accelerate uniformly in a current direction based on the first acceleration until the speed of the first virtual character increases to the maximum speed. Then, the first virtual character is controlled to continue to move uniformly in the current direction based on the maximum speed. In some embodiments, the current direction of the first virtual character may be a previous movement direction of the first virtual character or an orientation of the first virtual character, which is not limited in embodiments of this application.

In some embodiments, the foregoing acceleration state may be also referred to as a linear acceleration state, and in this case, the foregoing first operation is not the direction adjustment operation. Accordingly, the target movement state of the first virtual character may alternatively be an acceleration while turning state, and in this case, the first operation on the movement control is the direction adjustment operation. A movement parameter corresponding to the acceleration while turning state includes the first acceleration, the maximum speed, and a turning angular velocity of the first virtual character.

In conclusion, in the technical solutions provided in embodiments of this application, a virtual character is controlled to move in an acceleration state through an operation on a movement control, so that movement manners of the virtual character are enriched.

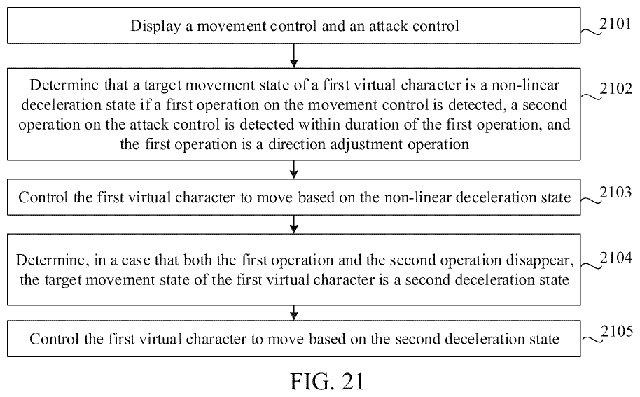

FIG. 19 is a flowchart of a virtual character control method according to another embodiment of this application. The method is performed by the terminal device 10 of the virtual character control system shown in FIG. 1, and operations may be performed by the client of the application in the terminal device 10. The method may include at least one operation in the following operations (1901-1905):

Operation 1901: Display a movement control and an attack control.

Operation 1902: Determine that a target movement state of a first virtual character is a non-linear deceleration state if a first operation on the movement control is detected, a second operation on the attack control is detected within duration of the first operation, and the first operation is a direction adjustment operation.

Operation 1903: Control the first virtual character to move based on the non-linear deceleration state. The foregoing operation 1901 to operation 1903 are similar to operation 1201 to operation 1203 in the embodiment of FIG. 12. For details, reference is made to the embodiment of FIG. 12. Details are not described herein.

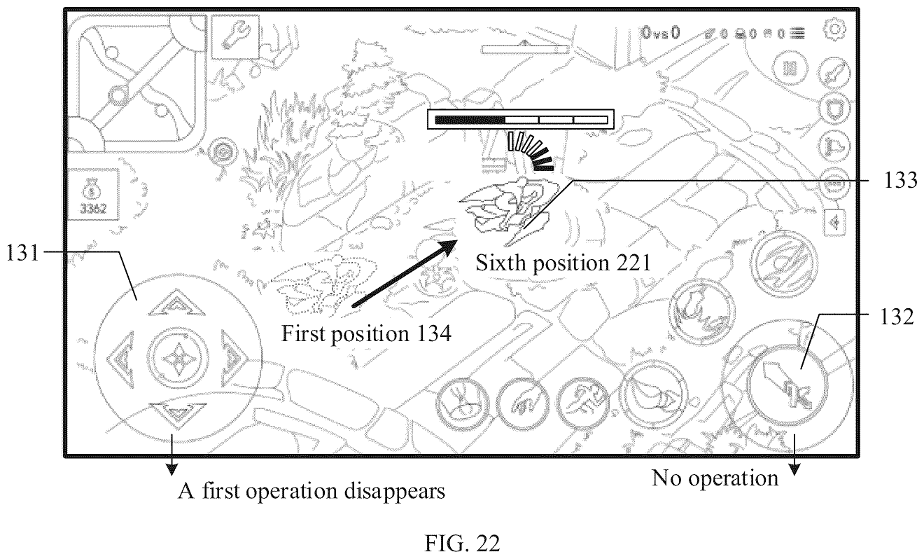

Operation 1904: Determine, when the first operation disappears but the second operation is present, that the target movement state of the first virtual character is a first deceleration state. In this embodiment of this application, the first deceleration state is a movement state in which quick deceleration is performed during linear movement of the first virtual character. For example, as shown in FIG. 20, when it is detected that a first operation on a movement control 131 disappears and a second operation on an attack control 132 is detected, the client controls a first virtual character 133 to move from a first position 134 to a fifth position 201 in a quick deceleration manner.

Operation 1905: Control the first virtual character to move based on the first deceleration state. In an exemplary embodiment, the foregoing operation 1905 includes at least one of the following operations:

1: Obtain a movement parameter corresponding to the first deceleration state.

In this embodiment of this application, after determining that the target movement state of the first virtual character is the first deceleration state, the client obtains the movement parameter corresponding to the first deceleration state. The movement parameter includes a third acceleration of the first virtual character, and the third acceleration is an acceleration corresponding to the first deceleration state.

In a possible implementation, the foregoing movement parameter corresponds only to the target movement state. In some embodiments, after determining that the target movement state of the first virtual character is the first deceleration state, the client directly obtains the movement parameter corresponding to the first deceleration state from a pre-configured parameter set.

In another possible implementation, the foregoing movement parameter is related to the target movement state and the second operation. In some embodiments, after determining that the target movement state of the first virtual character is the first deceleration state, the client obtains a basic movement parameter corresponding to the first deceleration state. The basic movement parameter includes a basic third acceleration of the first virtual character. Further, the client determines an offset movement parameter corresponding to the first deceleration state based on attribute information of the second operation. The offset movement parameter includes an offset third acceleration of the first virtual character. Then, the client determines the movement parameter corresponding to the first deceleration state based on the basic movement parameter and the offset movement parameter. In some embodiments, the foregoing basic movement parameter is obtained from a pre-configured parameter set. In some embodiments, attribute information of different types of second operations are different. Details are similar to the attribute information of the foregoing direction adjustment operation, which are not described herein.

In still another possible implementation, the foregoing movement parameter is related to the target movement state and an operation basis for determining the target movement state. For example, the operation basis of the first deceleration state is used as the second operation on the attack control. When obtaining the movement parameter, the client obtains a parameter corresponding to the second operation and a calculation rule corresponding to the first deceleration state. The client calculates the parameter corresponding to the second operation based on the calculation rule to obtain the foregoing movement parameter. In some embodiments, the parameter corresponding to the foregoing second operation is obtained from a pre-configured parameter set.

Using the foregoing third acceleration as an example, in obtaining the third acceleration, a second acceleration and a fourth acceleration are obtained. The second acceleration is an acceleration corresponding to the operation on the attack control, and the fourth acceleration is an acceleration corresponding to a second deceleration state. The third acceleration of the first virtual character is determined based on the second acceleration and the fourth acceleration. In this embodiment of this application, the client determines the third acceleration of the first virtual character based on the second acceleration and the fourth acceleration as well as the calculation rule corresponding to the first deceleration state.

2: Control the first virtual character to move based on the third acceleration.

In some embodiments, the third acceleration is for representing a value change speed of a speed of the first virtual character in the first deceleration state. In this embodiment of this application, the client controls the first virtual character to slow down uniformly in a current direction based on the third acceleration until the speed of the first virtual character decreases to zero.

In some embodiments, the current direction of the first virtual character may be a previous movement direction of the first virtual character or an orientation of the first virtual character, which is not limited in embodiments of this application.

In conclusion, in the technical solutions provided in embodiments of this application, after an operation on a movement control disappears, a virtual character is controlled to move in a first deceleration state through an operation on an attack control, so that movement manners of the virtual character are enriched.

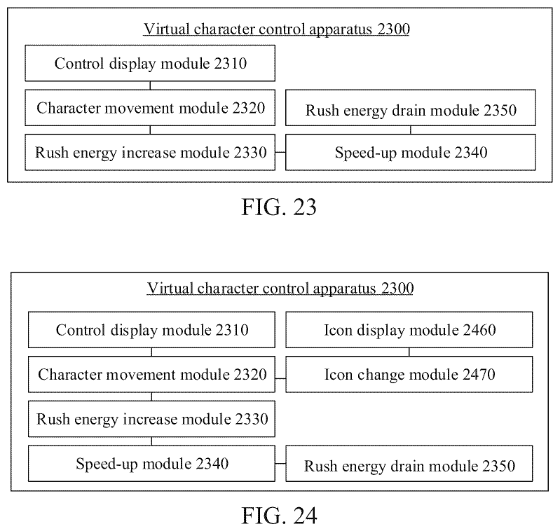

FIG. 21 is a flowchart of a virtual character control method according to another embodiment of this application. The method is performed by the terminal device 10 of the virtual character control system shown in FIG. 1, and operations may be performed by the client of the application in the terminal device 10. The method may include at least one operation in the following operations (2101-2105):

Operation 2101: Display a movement control and an attack control.

Operation 2102: Determine that a target movement state of a first virtual character is a non-linear deceleration state if a first operation on the movement control is detected, a second operation on the attack control is detected within duration of the first operation, and the first operation is a direction adjustment operation.

Operation 2103: Control the first virtual character to move based on the non-linear deceleration state. The foregoing operation 2101 to operation 2103 are similar to operation 1201 to operation 1203 in the embodiment of FIG. 12. For details, reference is made to the embodiment of FIG. 12. Details are not described herein.

Operation 2104: Determine, when both the first operation and the second operation disappear, the target movement state of the first virtual character is a second deceleration state.

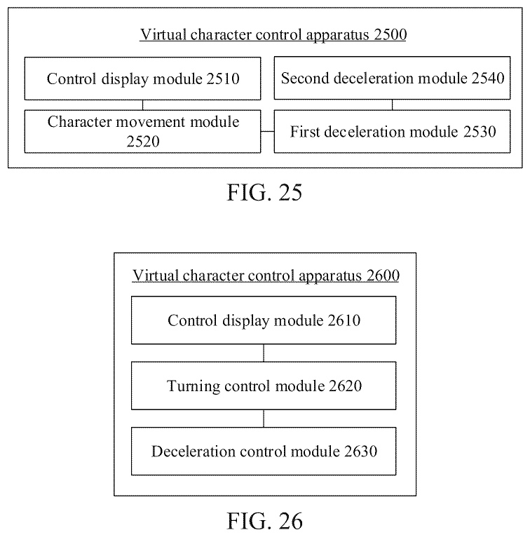

In this embodiment of this application, the second deceleration state is a movement state in which normal deceleration is performed during linear movement of the first virtual character. For example, as shown in FIG. 22, when it is detected that a first operation on a movement control 131 disappears and no operation on an attack control 132 is detected, the client controls a first virtual character 133 to move from a first position 134 to a sixth position 221 in a quick deceleration manner.

Operation 2105: Control the first virtual character to move based on the second deceleration state. In an exemplary embodiment, the foregoing operation 2105 includes at least one of the following operations:

1: Obtain a movement parameter corresponding to the second deceleration state.

In this embodiment of this application, after determining that the target movement state of the first virtual character is the second deceleration state, the client obtains the movement parameter corresponding to the second deceleration state. The movement parameter includes a fourth acceleration of the first virtual character, and the fourth acceleration is an acceleration corresponding to the second deceleration state.

In a possible implementation, the foregoing movement parameter corresponds only to the target movement state. In some embodiments, after determining that the target movement state of the first virtual character is the second deceleration state, the client directly obtains the movement parameter corresponding to the second deceleration state from a pre-configured parameter set.

In another possible implementation, the foregoing movement parameter is related to the target movement state and an operation basis for determining the target movement state. For example, the operation basis of the second deceleration state disappears as the first operation on the movement control. When obtaining the movement parameter, the client obtains a parameter corresponding to the first operation and a calculation rule corresponding to the second deceleration state, and then calculates, based on the calculation rule, the corresponding parameter when the first operation disappears, to obtain the foregoing movement parameter. In some embodiments, the corresponding parameter when the foregoing first operation disappears is obtained from a pre-configured parameter set.

2: Control the first virtual character to move based on the fourth acceleration.

In some embodiments, the fourth acceleration is for representing a value change speed of a speed of the first virtual character in the second deceleration state. In this embodiment of this application, the first virtual character is controlled to slow down uniformly in a current direction based on the fourth acceleration until the speed of the first virtual character decreases to zero.

In some embodiments, the current direction of the first virtual character may be a previous movement direction of the first virtual character or an orientation of the first virtual character, which is not limited in embodiments of this application.

In conclusion, in the technical solutions provided in embodiments of this application, after an operation on a movement control disappears and when no operation on an attack control is detected, a virtual character is controlled to move in a second deceleration state, so that movement manners of the first virtual character are enriched.

The foregoing descriptions of this application by way of embodiments are merely exemplary and explanatory, and new embodiments formed by any combination of the operations in the foregoing embodiments also fall within the scope of this application.

Apparatus embodiments of this application are described below, and may be used to implement the method embodiments of this application. For details not disclosed in the apparatus embodiments of this application, reference is made to the method embodiments of this application.

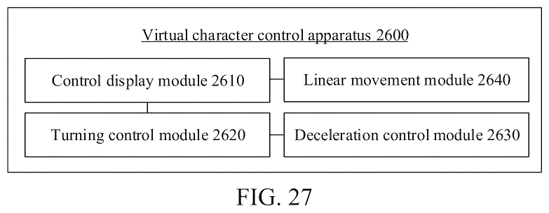

FIG. 23 is a block diagram of a virtual character control apparatus according to an embodiment of this application. The apparatus has functions of implementing the foregoing virtual character control method. The functions may be implemented by hardware or may be implemented by hardware executing corresponding software. The apparatus may be a terminal device or may be provided in a terminal device. The apparatus 2300 may include a control display module 2310, a character movement module 2320, a rush energy increase module 2330, a speed-up module 2340, and a rush energy drain module 2350.

The control display module 2310 is configured to display a movement control and an attack control. The movement control is a joystick control configured to control a first virtual character to move, and the attack control is configured to control the first virtual character to perform an attack action.

The character movement module 2320 is configured to control the first virtual character to move in response to a first operation on the movement control.

The rush energy increase module 2330 is configured to increase rush energy corresponding to the first virtual character in response to a second operation on the attack control when the first virtual character is in a moving state.

The speed-up module 2340 is configured to control the first virtual character to speed up when the rush energy satisfies a first condition. A movement speed of the first virtual character during the speed-up is higher than a movement speed of the first virtual character before the speed-up.

The rush energy drain module 2350 is configured to drain the rush energy corresponding to the first virtual character.

In an exemplary embodiment, the speed-up module 2340 is further configured to control the first virtual character to speed up in a target movement direction. The target movement direction is a movement direction of the first virtual character when the rush energy satisfies the first condition.

In an exemplary embodiment, the speed-up module 2340 is further configured to: perform, when no direction adjustment operation on the movement control is detected, the operation of controlling the first virtual character to speed up in a target movement direction; or control, when a direction adjustment operation on the movement control is detected, the first virtual character to speed up in a target direction indicated by the direction adjustment operation.

In an exemplary embodiment, the speed-up module 2340 is further configured to: control the first virtual character to accelerate until a movement speed of the first virtual character increases to a maximum speed corresponding to the speed-up; and control the first virtual character to decelerate until the movement speed of the first virtual character decreases from the maximum speed corresponding to the speed-up to the movement speed before the speed-up.

In an exemplary embodiment, the rush energy increase module 2330 is further configured to: update the rush energy based on an attack speed of the first virtual character in response to the second operation on the attack control, and display an increase process of the rush energy in a rush energy prompt bar; control, in response to the second operation on the attack control, the first virtual character to perform the attack action on a second virtual character within an attack range; and update the rush energy based on a quantity of hits of the attack action, and display an increase process of the rush energy in a rush energy prompt bar; or update the rush energy based on duration of the second operation in response to the second operation on the attack control, and display an increase process of the rush energy in a rush energy prompt bar.

In an exemplary embodiment, as shown in FIG. 24, the apparatus 2300 further includes an icon display module 2460 and an icon change module 2470.

The icon display module 2460 is configured to display a movement speed indication icon of the first virtual character. The movement speed indication icon is configured to indicate the movement speed of the first virtual character.

The icon change module 2470 is configured to change a display style of the movement speed indication icon based on the movement speed of the first virtual character.

FIG. 25 is a block diagram of a virtual character control apparatus according to another embodiment of this application. The apparatus has functions of implementing the foregoing virtual character control method. The functions may be implemented by hardware or may be implemented by hardware executing corresponding software. The apparatus may be a terminal device or may be provided in a terminal device. The apparatus 2500 may include a control display module 2510, a character movement module 2520, a first deceleration module 2530, and a second deceleration module 2540.

The control display module 2510 is configured to display a movement control and an attack control. The movement control is a joystick control configured to control a first virtual character to move, and the attack control is configured to control the first virtual character to perform an attack action.

The character movement module 2520 is configured to control the first virtual character to move in response to a first operation on the movement control.

The first deceleration module 2530 is configured to control the first virtual character to slow down when the first operation stops.

The second deceleration module 2540 is configured to control the first virtual character to slow down at an additional acceleration in response to a second operation on the attack control during the slow-down of the first virtual character, until the first virtual character stops moving.

In an exemplary embodiment, the second deceleration module 2540 is further configured to: obtain the additional acceleration in response to the second operation on the attack control during the slow-down of the first virtual character; update an acceleration corresponding to the slow-down based on the additional acceleration, to obtain an updated acceleration; and control the first virtual character to slow down based on the updated acceleration, until the first virtual character stops moving.

In an exemplary embodiment, the first deceleration module 2530 is configured to control the first virtual character to slow down uniformly based on an acceleration corresponding to the slow-down.

In an exemplary embodiment, the character movement module 2520 is further configured to: control the first virtual character to accelerate in response to the first operation on the movement control until a movement speed of the first virtual character reaches a maximum movement speed; and control the first virtual character to move uniformly at the maximum movement speed.

FIG. 26 is a block diagram of a virtual character control apparatus according to another embodiment of this application. The apparatus has functions of implementing the foregoing virtual character control method. The functions may be implemented by hardware or may be implemented by hardware executing corresponding software. The apparatus may be a terminal device or may be provided in a terminal device. The apparatus 2600 may include a control display module 2610, a turning control module 2620, and a deceleration control module 2630.

The control display module 2610 is configured to display a movement control and an attack control. The movement control is a joystick control configured to control a first virtual character to move, and the attack control is configured to control the first virtual character to perform an attack action.

The turning control module 2620 is configured to control the first virtual character to turn in response to a direction adjustment operation on the movement control.

The deceleration control module 2630 is configured to control, in response to an operation on the attack control during the turning of the first virtual character, the first virtual character to decelerate while turning.

In an exemplary embodiment, the turning control module 2620 is further configured to: obtain a target direction indicated by the direction adjustment operation as well as a turning acceleration, turning angular velocity, and maximum turning speed corresponding to the turning; and control the first virtual character to turn based on the turning acceleration, turning angular velocity, and maximum turning speed corresponding to the turning, and control a movement direction of the first virtual character to change toward the target direction during the turning.

In an exemplary embodiment, the deceleration control module 2630 is further configured to: obtain a target direction indicated by the direction adjustment operation as well as a turning acceleration, turning angular velocity, and maximum turning speed corresponding to the deceleration while turning; and control, based on the turning acceleration, turning angular velocity, and maximum turning speed corresponding to the deceleration while turning, the first virtual character to decelerate while turning, and control a movement direction of the first virtual character to change toward the target direction during the deceleration while turning. An orientation change speed of the first virtual character is higher than a movement direction change speed during the deceleration while turning.

In an exemplary embodiment, as shown in FIG. 27, the apparatus 2600 further includes a linear movement module 2640.

The linear movement module 2640 is configured to: control the first virtual character to move linearly in response to a non-direction-adjustment operation on the movement control; and control the first virtual character to decelerate linearly in response to the operation on the attack control during the linear movement of the first virtual character.

For the apparatus provided in the foregoing embodiments, when implementing the functions of the apparatus, only division of the function modules is described by using examples. During practical application, the functions are completed by different function modules as required. In other words, an internal structure of the device is divided into different function modules to complete all or some of the functions described above. In addition, the apparatuses provided in the foregoing embodiments and the method embodiments fall within the same conception. For details of a specific implementation process, reference is made to the method embodiments. Details are not described herein again. For the beneficial effects of the foregoing apparatus embodiments, reference is also made to the foregoing embodiments. Details are not described herein.

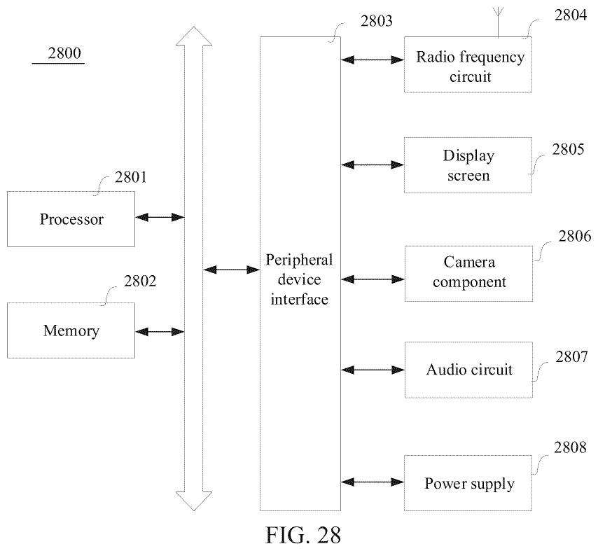

FIG. 28 shows a terminal device 2800 according to an embodiment of this application. The terminal device 2800 may be an electronic device such as a mobile phone, a tablet computer, a game console, an e-book reader, a multimedia playback device, a wearable device, a personal computer (PC), a smart voice interaction device, or a smart home appliance. This terminal device 2800 is configured to implement the functions of the foregoing virtual character control method. Specifically,
the terminal device 2800 generally includes a processor 2801 and a memory 2802.

The processor 2801 may include one or more processing cores, for example, a 4-core processor or an 8-core processor. The processor 2801 may be implemented in at least one hardware form of digital signal processing (DSP), a field programmable gate array (FPGA), or a programmable logic array (PLA). The processor 2801 may alternatively include a main processor and a coprocessor. The main processor is a processor configured to process data in an awake state, and is also referred to as a central processing unit (CPU). The coprocessor is a low-power-consumption processor configured to process data in a standby state. In some embodiments, the processor 2801 may be integrated with a graphics processing unit (GPU). The GPU is configured to render and draw content that needs to be displayed on a display screen. In some embodiments, the processor 2801 may further include an artificial intelligence (AI) processor. The AI processor is configured to process computing operations related to machine learning.

The memory 2802 may include one or more computer-readable storage media. The computer-readable storage medium may be non-transient. The memory 2802 may further include a high-speed random access memory and a nonvolatile memory, for example, one or more disk storage devices or flash storage devices. In some embodiments, the non-transient computer-readable storage medium in the memory 2802 is configured to store at least one program. The at least one program is configured to be executed by the processor to implement the foregoing virtual character control methods.

In some embodiments, the terminal device 2800 further includes a peripheral device interface 2803 and at least one peripheral device. The processor 2801, the memory 2802, and the peripheral device interface 2803 may be connected through a bus or a signal line. Each peripheral device may be connected to the peripheral device interface 2803 through the bus, the signal line, or a circuit board. Specifically, the peripheral device includes at least one of a radio frequency circuit 2804, a display screen 2805, a camera component 2806, an audio circuit 2807, or a power supply 2808.

A person skilled in the art may understand that the structure shown in FIG. 28 does not constitute a limitation to the terminal device 2800, and the terminal device may include more or fewer components than those shown in the figure, or some components may be combined, or a different component deployment may be used.

In an exemplary embodiment, a non-transitory computer-readable storage medium is further provided, having a computer program stored thereon, the computer program, when executed by a processor of a computer device, causing the computer device to implement the foregoing virtual character control methods.

In some embodiments, the computer-readable storage medium may include a read only memory (ROM), a random access memory (RAM), a solid state drive (SSD), an optical disc, or the like. The random access memory may include a resistance random access memory (ReRAM) and a dynamic random access memory (DRAM).

In an exemplary embodiment, a computer program product is further provided, including a computer program stored on a computer-readable storage medium, a processor of a terminal device reading the computer program from the computer-readable storage medium, and the processor executing the computer program, to cause the terminal device to implement the foregoing virtual character control methods.

“Plurality of” mentioned in the specification means two or more. “And/or” describes an association relationship between associated objects and indicates that three relationships may exist. For example, A and/or B may indicate the following three cases: Only A exists, both A and B exist, and only B exists. The character “/” in this specification generally indicates an “or” relationship between the associated objects. In addition, the operation numbers described in this specification merely exemplarily show a possible execution sequence of the operations. In some other embodiments, the operations may not be performed in a number sequence. For example, two operations with different numbers may be performed simultaneously, or two operations with different numbers may be performed in a sequence contrary to the sequence shown in the figure, which is not limited in embodiments of this application.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A virtual character control method performed by a computer device, the method comprising:
displaying a movement control and an attack control on a virtual scene;
in response to a first operation on the movement control by a user of the computer device, controlling the first virtual character to move at a movement speed in the virtual scene;
while the first virtual character remains in a moving state in the virtual scene, increasing rush energy corresponding to the first virtual character in response to a second operation on the attack control by the user of the computer device; and
when the rush energy satisfies a first condition, controlling the first virtual character to accelerate the movement speed until the rush energy corresponding to the first virtual character is drained.

2. The method according to claim 1, wherein the controlling the first virtual character to accelerate the movement speed comprises:
controlling the first virtual character to accelerate the movement speed in a target movement direction of the first virtual character when the rush energy satisfies the first condition.

3. The method according to claim 2, further comprising:
when a direction adjustment operation on the movement control is detected, controlling the first virtual character to accelerate the movement speed in a target direction indicated by the direction adjustment operation.

4. The method according to claim 2, wherein the controlling the first virtual character to accelerate the movement speed in a target movement direction comprises:
controlling the first virtual character to accelerate until the movement speed of the first virtual character increases to a maximum speed; and
controlling the first virtual character to decelerate until the movement speed of the first virtual character decreases from the maximum speed to the movement speed before the acceleration.

5. The method according to claim 1, wherein the increasing rush energy corresponding to the first virtual character in response to a second operation on the attack control comprises:
in response to the second operation on the attack control:
updating the rush energy based on an attack speed of the first virtual character;
controlling the first virtual character to perform the attack action on a second virtual character within an attack range; and
updating the rush energy based on a quantity of hits of the attack action, and displaying an increase process of the rush energy in a rush energy prompt bar.

6. The method according to claim 1, further comprising:
displaying a movement speed indication icon of the first virtual character; and
changing a display style of the movement speed indication icon based on the acceleration of the movement speed of the first virtual character.

7. The method according to claim 1, wherein the attack control is a skill attack control in an abnormal response state configured to control the first virtual character to perform a skill attack without needing to consume virtual resources during performance, and the abnormal response state is a state in which the skill attack control cannot control the first virtual character to cast a corresponding skill.

8. A computer device, comprising a processor and a memory, the memory having a computer program stored therein, and the computer program, when executed by the processor, causing the computer device to implement a virtual character control method including:
displaying a movement control and an attack control on a virtual scene;
in response to a first operation on the movement control by a user of the computer device, controlling the first virtual character to move at a movement speed in the virtual scene;
while the first virtual character remains in a moving state in the virtual scene, increasing rush energy corresponding to the first virtual character in response to a second operation on the attack control by the user of the computer device; and
when the rush energy satisfies a first condition, controlling the first virtual character to accelerate the movement speed until the rush energy corresponding to the first virtual character is drained.

9. The computer device according to claim 8, wherein the controlling the first virtual character to accelerate the movement speed comprises:
controlling the first virtual character to accelerate the movement speed in a target movement direction of the first virtual character when the rush energy satisfies the first condition.

10. The computer device according to claim 9, wherein the method further comprises:
when a direction adjustment operation on the movement control is detected, controlling the first virtual character to accelerate the movement speed in a target direction indicated by the direction adjustment operation.

11. The computer device according to claim 9, wherein the controlling the first virtual character to accelerate the movement speed in a target movement direction comprises:
controlling the first virtual character to accelerate until the movement speed of the first virtual character increases to a maximum speed; and
controlling the first virtual character to decelerate until the movement speed of the first virtual character decreases from the maximum speed to the movement speed before the acceleration.

12. The computer device according to claim 8, wherein the increasing rush energy corresponding to the first virtual character in response to a second operation on the attack control comprises:
in response to the second operation on the attack control:
updating the rush energy based on an attack speed of the first virtual character;
controlling the first virtual character to perform the attack action on a second virtual character within an attack range; and
updating the rush energy based on a quantity of hits of the attack action, and displaying an increase process of the rush energy in a rush energy prompt bar.

13. The computer device according to claim 8, wherein the method further comprises:
displaying a movement speed indication icon of the first virtual character; and
changing a display style of the movement speed indication icon based on the acceleration of the movement speed of the first virtual character.

14. The computer device according to claim 8, wherein the attack control is a skill attack control in an abnormal response state configured to control the first virtual character to perform a skill attack without needing to consume virtual resources during performance, and the abnormal response state is a state in which the skill attack control cannot control the first virtual character to cast a corresponding skill.

15. A non-transitory computer-readable storage medium, having a computer program stored thereon, the computer program, when executed by a processor of a computer device, causing the computer device to implement a virtual character control method including:
displaying a movement control and an attack control on a virtual scene;
in response to a first operation on the movement control by a user of the computer device, controlling the first virtual character to move at a movement speed in the virtual scene;
while the first virtual character remains in a moving state in the virtual scene, increasing rush energy corresponding to the first virtual character in response to a second operation on the attack control by the user of the computer device; and
when the rush energy satisfies a first condition, controlling the first virtual character to accelerate the movement speed until the rush energy corresponding to the first virtual character is drained.

16. The non-transitory computer-readable storage medium according to claim 15, wherein the controlling the first virtual character to accelerate the movement speed comprises:
controlling the first virtual character to accelerate the movement speed in a target movement direction of the first virtual character when the rush energy satisfies the first condition.

17. The non-transitory computer-readable storage medium according to claim 16, wherein the method further comprises:
when a direction adjustment operation on the movement control is detected, controlling the first virtual character to accelerate the movement speed in a target direction indicated by the direction adjustment operation.

18. The non-transitory computer-readable storage medium according to claim 16, wherein the controlling the first virtual character to accelerate the movement speed in a target movement direction comprises:
controlling the first virtual character to accelerate until the movement speed of the first virtual character increases to a maximum speed; and
controlling the first virtual character to decelerate until the movement speed of the first virtual character decreases from the maximum speed to the movement speed before the acceleration.

19. The non-transitory computer-readable storage medium according to claim 15, wherein the increasing rush energy corresponding to the first virtual character in response to a second operation on the attack control comprises:
in response to the second operation on the attack control:
updating the rush energy based on an attack speed of the first virtual character;
controlling the first virtual character to perform the attack action on a second virtual character within an attack range; and
updating the rush energy based on a quantity of hits of the attack action, and displaying an increase process of the rush energy in a rush energy prompt bar.

20. The non-transitory computer-readable storage medium according to claim 15, wherein the method further comprises:
displaying a movement speed indication icon of the first virtual character; and
changing a display style of the movement speed indication icon based on the acceleration of the movement speed of the first virtual character.
